(19) United States
(12) Patent Application Publication
(10) Pub. No.: US 2011/0303191 A1
(43) Pub. Date: Dec. 15, 2011

(54) Low-cost type mackay four-stroke engine system

(76) Inventor: Lung Tan Hu, Langley (CA)

(21) Appl. No.: 12/802,637

(22) Filed: Jun. 11, 2010

(51) Int. Cl. F15C 1/00

(52) U.S. Cl. 123/444

(57) ABSTRACT

The present invention provides an integrated engine system, which includes an air-compression means, an air-buffer-system, a fuel-supplying means, an power-management-unit, and at least two cold-expansion-chambers; wherein, each of said at least two cold-expansion-chambers operates with a Simplified Mackay Four-Stroke Cycle, which includes a first-intake-process, a compression-process, a hot-combustion-process, a second-intake-process, a cold-expansion-process, and an exhaust-process.

The expansion temperature and the oxygen-gas concentration are accurately regulated in the 3rd-Stroke of the Simplified Mackay Four-Stroke Cycle; a hot-combustion-medium combusts at a high temperature during the hot-combustion-process; a programmed amount of high-boost-air is injected to mixed with the hot-combustion-medium during the second-intake-process that performs between 400-460 degree of crankshaft reference angle; an oxygen-rich cold-expansion-medium expands at a temperature lower than 1100 degree Celsius during the cold-expansion-process, thus accelerating the conversion from carbon-monoxide-gas to carbon-dioxide-gas in a low-temperature oxygen-rich condition.

### FIELD OF THE INVENTION

The present invention relates to a four-stroke type integrated engine system operating in a Simplified Mackay Four-Stroke Cycle with at least two cold-expansion-chambers, more particularly to a four-stroke type integrated engine system that operates in a cycle consisting of six processes, performing in the order of the first-intake-process, the compression-process, the hot-combustion-process, the second-intake-process, the cold-expansion-process, and the exhaust-process; wherein the expansion pressure and the expansion temperature in the 3rd-Stroke are precisely regulated with the power-management-unit.

The present invention can be used in the field of automobile, transportation, and commercial power generation.

### BACKGROUND OF THE INVENTION

The present invention is a further developed engine system based on the cold-expansion concept in the eight-stroke-cycle used in an eight-stroke-engine, which is now U.S. Pat. No. 6,918,358; the theory of the eight-stroke-cycle is to reduce the heat dissipation by way of releasing fuel energy in two processes, thereby shortening the time that the combustion-medium is heating the cylinder wall and the cylinder head, so a better fraction of the fuel energy is converted in a low-temperature oxygen-rich condition for producing power with the least heat-loss.

The abovementioned two processes are the hot-combustion-process and the cold-expansion-process; the hot-combustion-process will combust the fuel and the air at a high temperature (about 2500 degree Celsius to 1400 degree Celsius) as a hot-combustion-medium, the hot-combustion-medium consists of nitrogen-gas, carbon-monoxide-gas, and other hot gases (except carbon-dioxide-gas due to the combustion temperature); the second-intake-process will mix a controlled amount of pressurized air with the hot-combustion-medium, thereby blocking the heat-loss by an instant cooling effect that rapidly cools the average temperature of the hot-combustion-medium down by 30%-80%, thereafter forming a low-temperature oxygen-rich cold-expansion-medium at a precisely regulated temperature range (400-1100 degree Celsius) according to the engine load; next the cold-expansion-medium expands with almost no heat-loss since the temperature difference between the cold-expansion-medium and the cylinder wall is now reduced significantly, which stops the heat current from conducting throughout the cylinder wall to the cooling circulation of the engine, and the conversion of the carbon-dioxide-gas is accelerated due to the high oxygen-gas concentration presented in the cold-expansion-medium; therefore, almost all the carbon-monoxide-gas is converted into the carbon-dioxide-gas before the completion of the down-stroke, yielding a high average expansion pressure during the down-stroke of the piston, which results in a highly efficient power-stroke of virtually minimal heat-loss; in other words, the eight-stroke-cycle allows the fuel energy to be released in two distinctive steps (the hot-combustion-process and the cold-expansion-process), instead of the sudden release of thermal energy that occurs in the conventional engine.

In a regular (medium load) operation with the optimal efficiency of the eight-stroke-cycle, the cold-expansion-medium is expanding with an average temperature of about 850-600 degree Celsius during the cold-expansion-process, the heat-current dissipating throughout the cylinder wall of the eight-stroke engine is significantly lower than that of the convention engine (gasoline type), whereas the exhaust-gas of the conventional engine has an average temperature of about 1500 degree Celsius or higher during the power-stroke, and an average temperature of about 1400 degree Celsius during the exhaust-stroke.

As the heat current is directly proportional to the temperature difference between the combusting medium and cylinder wall, it can be seen that the total heat-current conducted over time (or the heat-loss) of the eight-stroke-engine is roughly about half of that of the conventional engine; therefore the eight-stroke-cycle is capable of performing at a relatively higher energy efficiency and power-to-weight ratio than the conventional engine.

Additionally the eight-stroke-engine only requires a cooling-system of about half cooling capacity in comparison to the conventional engine, which also reduces the weight of the entire engine system.

However, there are a few drawbacks on the eight-stroke-engine, one of which is the high cost of the variable crankshaft control system of the slave-cylinder of the eight-stroke-engine and the variable-timing-coordinate-valve-system that makes it difficult for the eight-stroke-engine to adapt to the automobile applications.

As the automobile applications require a demanding acceleration performance that can instantly accelerate from 10% of the maximum engine output to 100% of the maximum engine output in about 3 or 4 seconds.

After testing the eights-stroke-engine with various prototypes for years, my research team has gathered enough data to conclude with a better engine system, named Mackay Cold-Expansion Engine System, which operates in a Mackay Cold-Expansion Cycle consisting of the first-intake-process, the hot-combustion-process, the fuel-cooling-process, the second-intake-process, the cold-expansion-process, and the exhaust-process; wherein the fuel-cooling-process requires an internal fuel supplying means for each cold-expansion-chamber and the fuel-cooling-process may be disabled in the light load operation or the engine idling operation.

However, the high performance comes with a high manufacturing cost, the original Mackay Cold-Expansion Engine System (MCES) requires internal fuel-injectors, internal high-volume air-injectors, a servo-type exhaust-valve, and a much more complicated control circuit than the conventional engine; therefore the MCES may take a few more years before the total cost of abovementioned engine components can be reduced to a more affordable level for the average consumers who demand low service costs and purchase prices, even though the Mackay Cold-Expansion Engine System (MCES) is considered to have a higher efficiency and a better power-to-weight-ratio.

Therefore, the main objective of the present invention is to provide an alternative inexpensive engine system capable of performing at a little less fuel efficiency than the original Mackay Cold-Expansion Cycle, but manufacturing at a low cost for the well-being of the average consumers; wherein this low-cost type integrated engine system operates with a Simplified Mackay Four-Stroke Cycle and an energy-saving mode for reserving the heat energy in an engine idling operation or an brake operation.

The Low-Cost Type Mackay Four-Stroke Engine System (MFES) consists of a speed-controlled air-compression means, a reenergize-buffer, at least two cold-expansion-chambers, and a power-management-unit.

The Simplified Mackay Four-Stroke Cycle of the Low-Cost Type Mackay Four-Stroke Engine System (MFES) also inherits the idea of the two combustion processes from the eight-stroke cycle, so said Simplified Mackay Four-Stroke Cycle includes the first-intake-process, the compression-process, the hot-combustion-process, the second-intake-process, the cold-expansion-process, and the exhaust-process; wherein the first-intake-process and the compression-process will fill in an air-fuel-mixture in the cold-expansion-chamber before 360 degree of crankshaft reference angle, and said air-fuel-mixture is ignited with an ignition means to produce a hot-combustion-medium; the average pressure of the hot-combustion-medium will start to decrease as the piston moves toward BDC; for example, in a medium load operation, the hot-combustion-medium may reach a peak pressure of about 500 psig at about 370 degree of crankshaft reference angle; thereafter, the pressure of the hot-combustion-medium starts to decrease to a point lower than the operation pressure of the reenergize-buffer at about 420 degree of crankshaft reference angle, at this time, the reenergize-air-injector injects a controlled amount of high-boost-air into the hot-combustion-medium to instantly cool the hot-combustion-medium by 30%-80%, thereby forming a cold-expansion-medium at a temperature lower than 1100 degree Celsius, (the cold-expansion-medium will form at about 400-750 degree Celsius in the light load operation, about 600-900 degree Celsius in the medium load operation, about 750-1100 degree Celsius in the heavy load operation); to achieve the best overall energy efficiency, the amount of the injected high-boost-air of the second-intake-process will vary significantly in different load conditions, therefore the power-management-unit needs to control both the operation speed of the speed-controlled air-compression means and the actuation-time of each reenergize-air-injector in order to precisely control the temperature of the cold-expansion-medium and the oxygen-gas concentration of the cold-expansion-medium, which are the most important factors of the present invention, so the power-management-unit may include sensor means for monitoring the expansion conditions (such as the surge pressure, the expansion temperature, the chamber temperature, the oxygen-concentration in the expelled cold-expansion-medium).

In comparison to the conventional engine, the MFES will have a relatively higher average expansion pressure and a relatively lower average expansion temperature during the entire down-stroke of the piston, and the exhaust-temperature of the MFES is at least 40% lower than the conventional engine of the same power output; therefore the heat energy dissipated into the engine cooling system of the MFES is only about 7%-15% of the total fuel energy, whereas the conventional engine dissipates about 35% of the total fuel energy in the engine cooling system.

For the ease of comprehension, a MFES and a conventional engine of the equivalent power output are compared at their standard energy efficiencies as follows:

The hot-combustion-medium of the MFES will be heating the chamber wall at an average temperature about 1600-2000 degree Celsius during the hot-combustion-process (a duration about 45 degree of crankshaft rotation), and then heating the chamber wall at an average temperature about 500-800 degree Celsius from the second-intake-process to the exhaust-process (a total duration about 270 degree of crankshaft rotation).

Whereas the working-medium of the conventional engine (4-stroke spark-ignition) will be heating the chamber wall at an average temperature about 1500-2000 degree Celsius during its combustion process (a duration about 160 degree of crankshaft rotation), and then heating the chamber wall at an average temperature about 1200-1400 degree during its exhaust-process (a duration about 180 degree of crankshaft rotation.

As the heat-loss of the MFES is significantly less than the conventional engine, this converts more a better fraction of the fuel energy into expansion force, to be more specific, the airflow-volume and the exhaust pressure measured at the exhaust-valve of the MFES are also relatively higher than the conventional engine; therefore, the MFES is also more preferable to include a heat-energy-recovering means (the heat-transfer-catalytic-converter) and a kinetic-energy-recovering means (the turbo-turbine and the turbo-compressor) to maximize the overall energy efficiency.

### SUMMARY OF THE INVENTION

1. The first objective of the present invention is to provide a Low-Cost Type Mackay Four-Stroke Engine System that is capable of performing the Simplified Mackay Four-Stroke Cycle, wherein said integrated engine system includes at least two cold-combustion-chambers for performing said Simplified Mackay Four-Stroke Cycle in the sequence of the first-intake-process, the compression-process, the hot-combustion-process, the second-intake-process, the cold-expansion-process, the exhaust-process.

2. The second objective of the present invention is to provide a Low-Cost Type Mackay Four-Stroke Engine System that can precisely control the expansion temperature of the cold-expansion-medium to be within the range of 400-1100 degree Celsius during the cold-expansion-process, thereby improving the overall energy efficiency and ensuring the functionality of the catalytic converter.

3. The third objective of the present invention is to provide a Low-Cost Type Mackay Four-Stroke Engine System that adjust the air-mass of the high-boost-air injected in the second-intake-process according to the engine operation condition, and the actuation timing of the reenergize-air-injection means is adjusted according to the pressure decline rate in the hot-combustion-process, such that the second-intake-process is started only after the pressure of the hot-combustion-medium has decreased to lower than the operation pressure of the reenergize-buffer.

4. The fourth objective of the present invention is to provide a Low-Cost Type Mackay Four-Stroke Engine System that can optimize the energy efficiency of the cold-expansion-process by the accelerated conversion of carbon-dioxide gas, such that the thermal energy of the injected fuel can be fully released in the form of expansion force prior to the exhaust-process.

5. The fifth objective of the present invention is to provide a Low-Cost Type Mackay Four-Stroke Engine System that can regulate the compression energy for performing the Simplified Mackay Four-Stroke Cycle; wherein the power-management-unit controls the airflow speeds of the high-boost-air in the reenergize-buffer by adjusting the operation speed of the air-compression means.

6. The sixth objective of the present invention is to provide an energy-efficient Low-Cost Type Mackay Four-Stroke Engine System that can increase energy efficiency by blocking the heat-current conducted from the cold-expansion-medium to the cold-expansion-chamber, thereby reducing the heat-loss of the cooling system to less than 15% of the total fuel energy.

7. The seventh objective of the present invention is to provide an efficient reenergize-buffer of the Low-Cost type Mackay Four-Stroke Engine that can recover the thermal energy from the expelling cold-expansion-medium to heat up the high-boost-air in the reenergize-buffer, thereby decreasing the workload on the air-compression means of the MFES.

8. The eighth objective of the present invention is to provide a Low-Cost Type Mackay Four-Stroke Engine System that can adjust ratio of the injected air-mass of the first-intake-process to the injected air-mass of the second-intake-process, in order to regulate the temperature of the cold-expansion-medium within the range of 400-1100 degree Celsius, thereby accelerating the conversion of carbon-monoxide-gas to carbon-dioxide-gas during the cold-expansion-process.

9. The ninth objective of the present invention is to provide a Low-Cost Type Mackay Four-Stroke Engine System that can perform in an energy-saving mode during the engine idling operation and the brake operation, wherein the second-intake-process is disabled to reserve the heat energy in the cold-expansion-chambers.

10. The tenth objective of the present invention is to provide a Low-Cost Type Mackay Four-Stroke Engine System that can adjust the vehicle-transmission-means to operate the cold-expansion-chambers at a programmed revolution speed that enables the cold-expansion-process to maintain a high power output.

### BRIEF DESCRIPTION OF THE DRAWINGS

FIG. 1A is an illustrative view of the first embodiment of the MFES, in which the heat-transfer-catalytic-converter and a turbo-charger is equipped in the preferred configuration.

FIG. 1B-1G shows the six processes of a Simplified Mackay Four-Stroke Cycle corresponding to Process Chart.2.

FIG. 1B shows the chamber condition in a first-intake-process at 30 degree of crankshaft reference angle.

FIG. 1C shows the chamber condition in a compression-process at 240 degree of crankshaft reference angle.

FIG. 1D shows the chamber condition in a hot-combustion-process at 350 degree of crankshaft reference angle.

FIG. 1E shows the chamber condition in a second-intake-process at 410 degree of crankshaft reference angle.

FIG. 1F shows the chamber condition in a cold-expansion-process at 435 degree of crankshaft reference angle.

FIG. 1G shows the chamber condition in an exhaust-process at 570 degree of crankshaft reference angle.

FIG. 2A is an illustrative view of the second embodiment of the MFES, in which a compression transmission, controlled by the power-management-unit, will regulate the operation speed of the air-compressor to maintain the operation pressure of the reenergize-buffer.

FIG. 2B is an illustrative view of the alternative embodiment of the MFES, in which an electric motor, controlled by the power-management-unit, will regulate the operation speed of the air-compressor to maintain the operation pressure of the reenergize-buffer.

FIG. 2C is an illustrative view of another alternative embodiment of the MFES, in which a fuel-injector is provided for each of the cold-expansion-chamber to perform a direct-injection for performing the diesel ignition or the direct-injection-spark-ignition.

FIG. 3 shows an operation flow chart to demonstrate the standard operation condition of the Simplified Mackay Four-Stroke Cycle.

The Process Chart.1-6 are shows the exemplary operation cycles in various conditions, it should be noted that each circular chart represents two revolution of the crankshaft rotation (720 degree of crankshaft rotation or 4 strokes of 180 degree crankshaft rotation), the top-dead-centre (TDC) position of the associated piston in the 1st-Stroke is referred as 0 degree of crankshaft reference angle, the bottom-dead-centre (BDC) position of the associated piston in the 2nd-Stroke is referred as 180 degree of crankshaft reference angle, the top-dead-centre (TDC) position of the associated piston in the 3rd-Stroke is referred as 360 degree of crankshaft reference angle, the bottom-dead-centre (BDC) position of the associated piston in the 4th-Stroke is referred as 540 degree of crankshaft reference angle.

Process Chart.1 demonstrates an exemplary Simplified Mackay Four-Stroke Cycle in a light load operation; wherein the second-intake-process is performed from 400 degree to 420 degree of crankshaft reference angle, assuming that the pressure of the hot-combustion-medium decreases to lower than the operation pressure of the reenergize-buffer at 400 degree of crankshaft reference angle.

Process Chart.2 demonstrates an exemplary Simplified Mackay Four-Stroke Cycle in a medium load operation; wherein the second-intake-process is performed from 420 degree to 435 degree of crankshaft reference angle, assuming that the pressure of the hot-combustion-medium decreases to lower than the operation pressure of the reenergize-buffer at 420 degree of crankshaft reference angle.

Process Chart.3 demonstrates an exemplary Simplified Mackay Four-Stroke Cycle in a heavy load operation; wherein the second-intake-process is performed from 430 degree to 450 degree of crankshaft reference angle, assuming that the pressure of the hot-combustion-medium decreases to lower than the operation pressure of the reenergize-buffer at 430 degree of crankshaft reference angle.

Process Chart.4 demonstrates an exemplary Simplified Mackay Four-Stroke Cycle performed with the direct-injection-spark-ignition in a light load operation; wherein the fuel is injected during the compression-process.

Process Chart.5 demonstrates an exemplary Simplified Mackay Four-Stroke Cycle performed with the direct-injection-spark-ignition in a heavy load operation; wherein the fuel is injected during both the first-intake-process and the compression-process.

Process Chart.6 demonstrates an exemplary diesel type Simplified Mackay Four-Stroke Cycle performed with the diesel direct-injection in a medium load operation; wherein the fuel is started to be injected at the end of the compression-process.

### DETAILED DESCRIPTION OF THE PREFERRED EMBODIMENTS

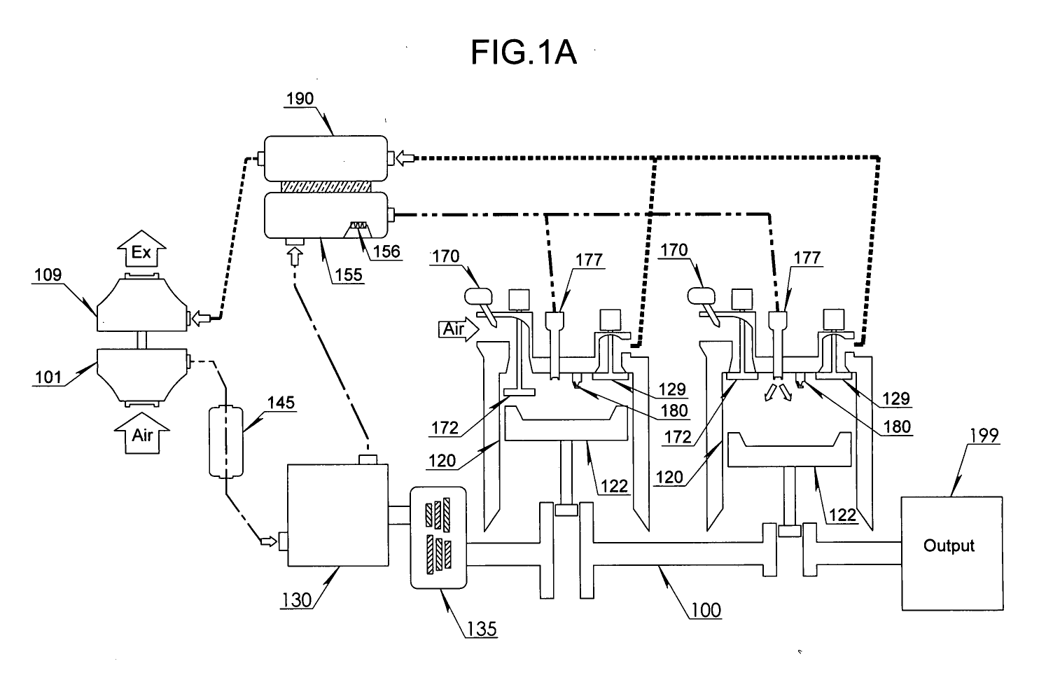

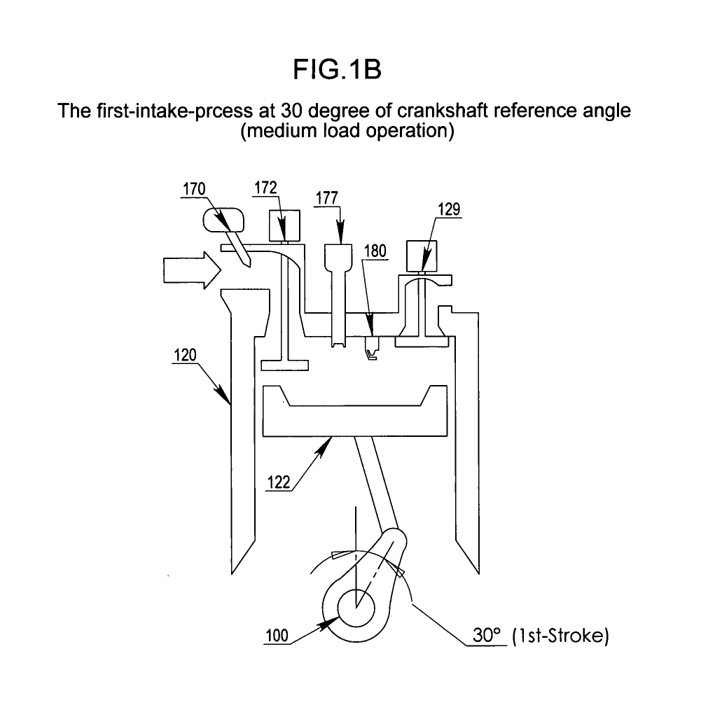

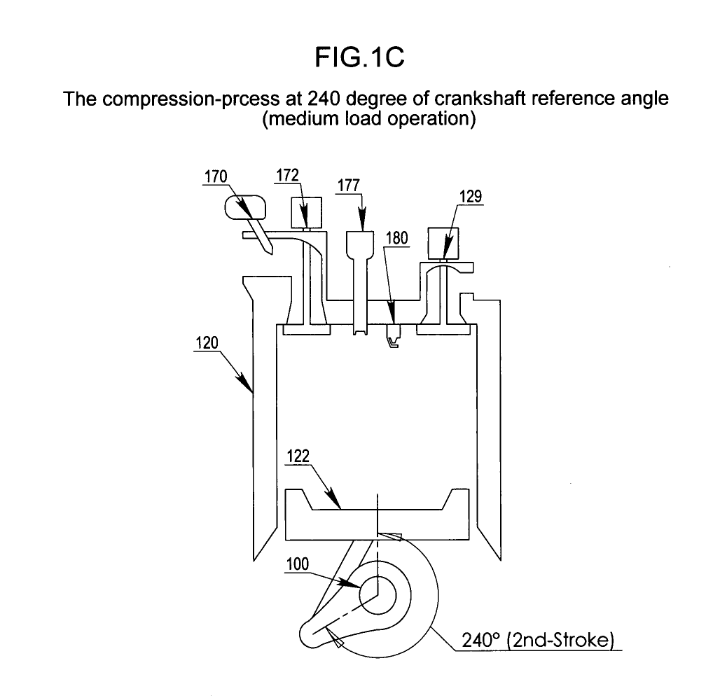

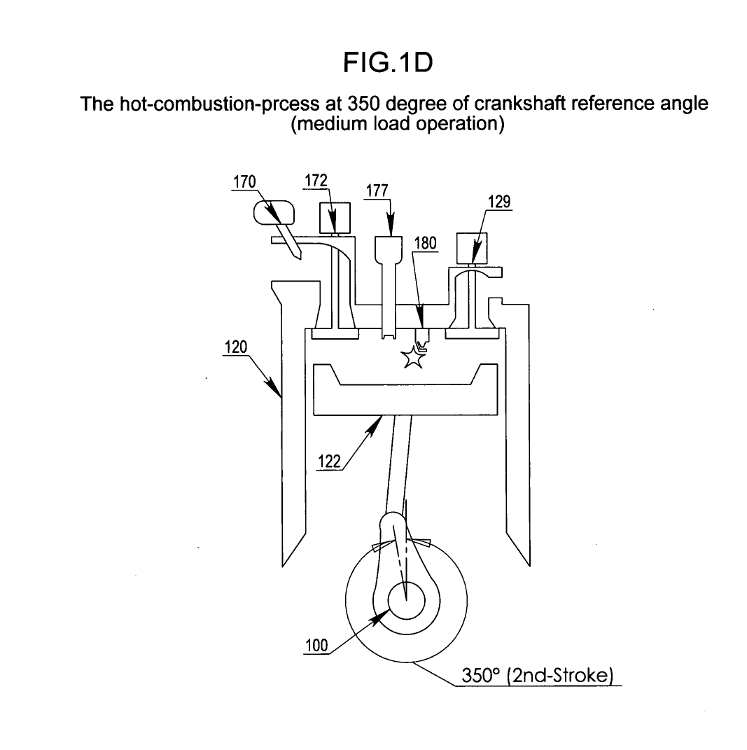

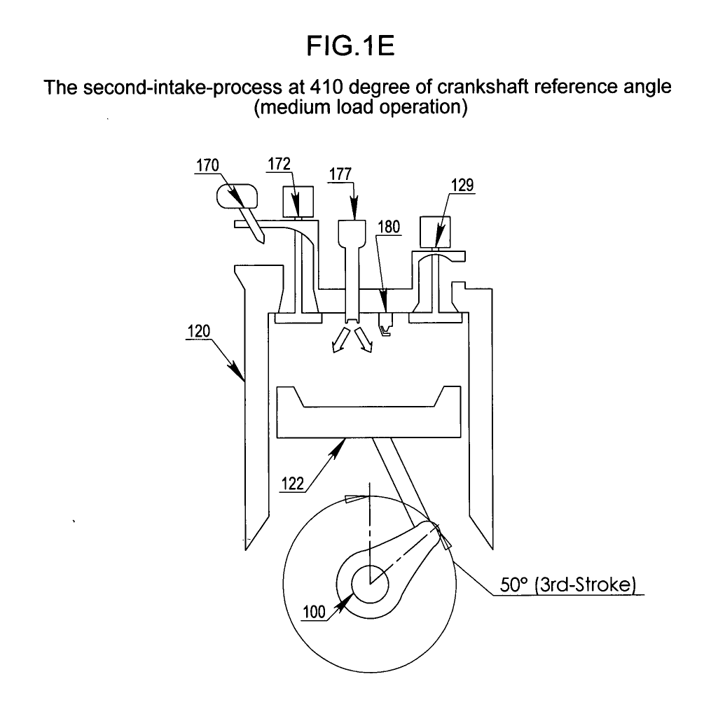

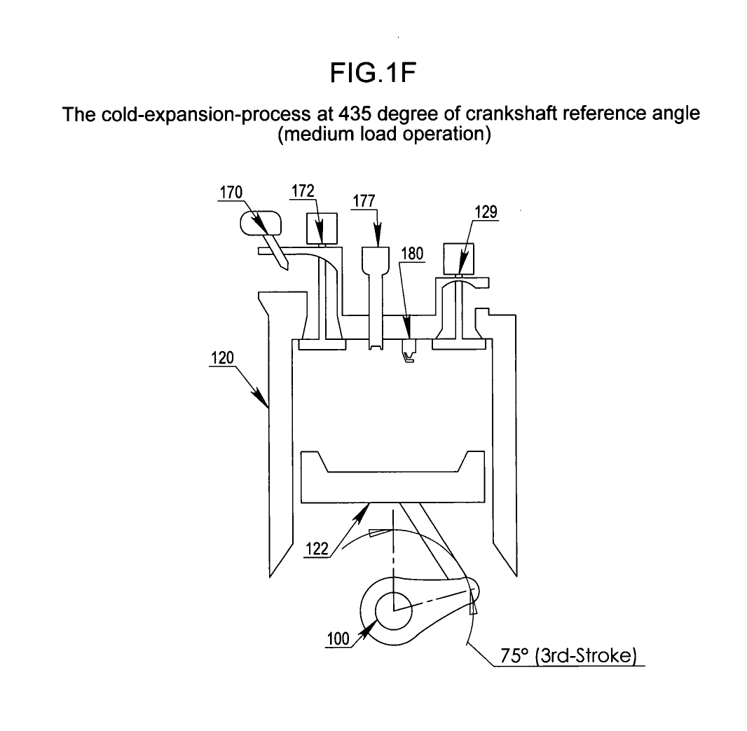

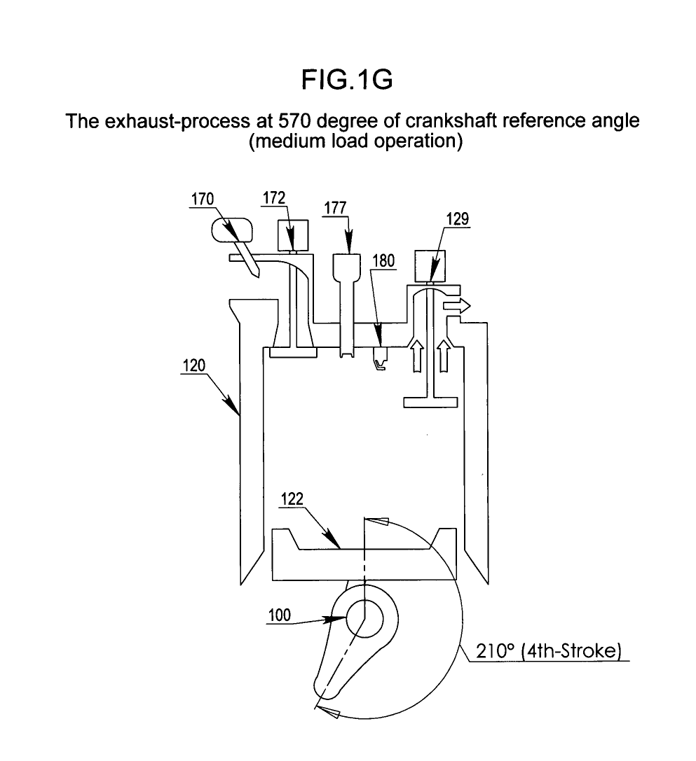

Referring to FIG. 1A for the first embodiment, this Low-Cost Type Mackay Four-Stroke Engine System (MFES) is one of the best forms of the present invention, in which the thermal energy and the kinetic energy of the expelled cold-expansion-medium are recovered by the reenergize-buffer to reduce the workload on the speed-controlled air-compression means.

In FIG. 1A, the components of MFES are labeled as the turbo-compressor 101, the turbo-turbine 109, the central-compressor 130, the compressor-cooler 145, the compressor-transmission 135, the air-intake-valves 172, the reenergize-buffer 155, the reenergize-air-injectors 177, the reenergize-buffer-sensor 156, the cold-expansion-chambers 120, the pistons 122, the fuel-injectors 170, the spark-plugs 180, the exhaust-valves 129, the heat-transfer-catalytic-converter 190, the crankshaft 100, and the output-shaft 199.

The MFES includes a power-management-unit for controlling the compression-transmission 135, the reenergize-air-injectors 177, the fuel-injectors 170, the spark-plugs 180, and the exhaust-valves 129 to perform a Simplified Mackay Four-Stroke Cycle in each cold-expansion-chamber.

The ambient air is inhaled into the turbo-compressor 101 to produce a flow of low-boost-air to the compression-cooler 145; the compressor-cooler 145 reduce the temperature of said low-boost-air by air-cooling with the ambient air; the cooled low-boost-air is supplied to the central compressor 130.

The central-compressor 130 will compress said low-boost-air to provide a flow of high-boost-air, and said high-boost-air is distributed to the reenergize-buffer 155; wherein the central-compressor 130 is driven at a controlled speed requested by the power-management-unit, thereby maintaining a preset operation pressure in the reenergize-buffer 155, and said operation pressure can be set in the range of 5-25 bar gauge depending on the material strength of the engine components.

The reenergize-buffer 155 will buffer and supply a heated high-boost-air to the reenergize-air-injector 177 at an operation pressure set by the power-management-unit according to the operation condition of the MFES; wherein a reenergize-buffer-sensor 156 will transmit the airflow data (such as pressure, airflow-mass, and temperature) to the power-management-unit, so that the power-management-unit can adjust operation speed of the central compressor 130 to maintain the air pressure in the reenergize-buffer 155; this is essential for the operation of the MFES because the air-pressure of said heated high-boost-air must be regulated above a minimum functional value in order for the reenergize-air-injectors to precisely control the injected air-mass during the second-intake-process.

The reenergize-buffer may include free-spinning turbines or rotors to stabilize the airflow speed of said heated high-boost-air, which can assist the reenergize-air-injectors to inject air at a more constant rate during the actuation of each reenergize-air-injector.

The compressor-transmission may be a mechanical transmission, a hydraulic transmission, or a continuous-variable-transmission; in the embodiments including an inverter system for driving a compressor-motor, functionality the compression-transmission of FIG. 1A is substituted by the compressor-motor for adjusting the operation speed of the air-compression means of high-boost-air.

The operation pressure setting of the reenergize-buffer 155 also depends on the overall compression efficiency of the air-compression means; ideally, if the air-compression means is a highly efficient air-compressor, the power-management-unit can be programmed to set an operation pressure of the reenergize-buffer to as high as 25 bar gauge, which allows the second-intake-process to be initiated at an earlier (smaller) crankshaft reference angle without losing any overall efficiency.

When the MFES is used in an automobile application, the operation pressure of the reenergize-buffer is preferred to be set in a range of 4-15 bar gauge for the public traffic safety, and a combustible-gas filter is preferred to be installed in the reenergize-buffer in order to prevent explosion.

For an example of a regular operation of the MFES shown in FIG. 1A, the power-management-unit keeps the operation pressure of the reenergize-buffer 155 within the programmed range by controlling the gear setting of the compression-transmission 130, wherein; the reenergize-buffer-sensor 156 will feedback the real-time airflow data of the reenergize-buffer 155 to the power-management-unit to confirm if a proper gear ratio is selected for keeping the operation pressure of the reenergize-buffer within the programmed range; generally, the compression-transmission should be set to a lower gear in a light load operation, while the compression-transmission should be set to a higher gear in a heavy load operation.

In short, the compressor-transmission 130 will shift to a higher gear to increase the airflow speed in the reenergize-buffer when the power-management-unit is requested to output more power by the user, in contrast, the compressor-transmission 130 will shift to a lower gear to decrease the airflow speed in the reenergize-buffer when the power-management-unit is requested to output less power by the user; at the same time, the reenergize-buffer-sensor 156 will continuously feedback said airflow data to the power-management-unit to check if the reenergize-buffer is under-pressured or over-pressured; as an over-pressured condition causes a loss in the efficiency, while an under-pressured causes a faulty operation of the reenergize-air-injectors 177 and an ineffective second-intake-process that fails to form a cold-expansion-medium.

The power-management-unit should also include a computation circuit for calculating the correct actuation time of the reenergize-air-injector 177 that can inject a programmed amount of the heated high-boost-air from the reenergize-buffer 155 during the second-intake-process; wherein said programmed amount of the heated high-boost-air should have an air-mass that is at least 50% of the air-mass taken in during the first-intake-process; in other words, for the regular operation, if the 100 mg of air is taken in during the first-intake-process, the heated high-boost-air of the second-intake-process must be at least 50 mg in order to cool the hot-combustion-medium to a temperature low enough for the acceleration of carbon-dioxide-gas to carbon-monoxide-gas.

In general, the air-mass injected in the second-intake-process may vary from 50%-250% of the air-mass taken in the first-intake-process, and this ratio is mostly depending on the compression efficiency of the speed-controlled air-compression means; however, it should be noted that the Simplified Mackay Four-Stroke Cycle is an unique operation cycle that can only achieve the highest efficiency if all the compression-efficiency and the expansion-efficiency and the expansion temperature are precisely controlled; in other words, the power-management-unit takes in the factors of the compression efficiency, the requested power output, and the real-time expansion-temperature of each cold-expansion-chamber, and next, the power-management-unit computes an operation speed of the speed-controlled air-compression means and an actuation-time of the reenergize-air-injection means in order to operate the MFES at the optimum efficiency.

In FIG. 1A the reenergize-buffer 155 will perform a reenergize-process, which recovers the thermal energy of the expelled cold-expansion-medium flown through the heat-transfer-catalytic-converter 190; wherein, the high-boost-air buffered in the reenergize-buffer 155 is heated up by the heat energy conducted from the heat-transfer-catalytic-converter 190; in general, the high-boost-air buffered in the reenergize-buffer 155 can be heated up to about 80-300 degree Celsius depending on the engine operation condition, which significantly decreases the required workload of the central-compressor 130 to keep the air-pressure in the reenergize-buffer 155 within its designated range, thereby raising the overall energy efficiency of the Simplified Mackay Four-Stroke Cycle.

As a supplementary note, the high-boost-air of the reenergize-buffer may be heated up to as high as 300 degree Celsius before injecting into each cold-expansion-chamber to mix with a hot-combustion-medium; the cooling effect of the second-intake-process is still effective because said hot-combustion-medium will be at a temperature of about 1400-2500 degree Celsius prior to the second-intake-process; therefore, by injecting a heated high-boost-air of 300 degree Celsius to mix with said hot-combustion-medium, it can still form a cold-expansion-medium in the target temperature range of 400-1100 degree Celsius; wherein the injected air-mass of the second-intake-process is to be controlled by the power-management-unit in a way, such that the compression energy consumed by the air-compression means does not cause a decrease in the overall energy efficiency; to be more specifically defined, the power-management-unit should limit the injected air-mass of the second-intake-process to be within 50%-250% of the injected air-mass of the first-intake-process, so that a hot-combustion-medium is mixed with a controlled amount of high-boost-air to form a cold-expansion-medium in a low-temperature oxygen-rich condition, wherein the temperature of said hot-combustion-medium will be reduced by 30%-80% after the completion of the second-intake-process, so that said cold-expansion-medium will expand at temperature of 400-1100 degree Celsius during the cold-expansion-process.

Now referring to FIG. 1A and Process Chart.2 for a detailed explanation of the Simplified Mackay Four-Stroke Cycle in a medium load operation; wherein a few assumptions on the temperature and pressure are made for the demonstration purpose and these assumptions are not to be considered as limitation elements of the invention.

The central-compressor 130 will supply a flow of high-boost-air at about 25 degree Celsius, the reenergize-buffer 155 takes in said high-boost-air to buffer a flow of heated high-boost-air to the reenergize-air-injectors 177 at a controlled air pressure (which is also referred as the operation pressure of the reenergize-buffer), the power-management-unit will keep said air pressure of the heated high-boost-air within a programmed range by adjusting the operation speed of the compression-transmission 130; the high-boost-air buffered in the reenergize-buffer is heated to higher than 150 degree Celsius by the heat energy conducted from the heat-transfer-catalytic-converter.

The cold-expansion-medium expelled out of each cold-expansion-chamber 120 will flow into the heat-transfer-catalytic-converter 190, and the reenergize-buffer 155 will absorb the thermal energy conducting from the heat-transfer-catalytic-converter, so that the high-boost-air buffered in the reenergize-buffer 155 will be heated up to a temperature of about 50-180 degree Celsius with the recovered thermal energy; next the expelled cold-expansion-medium charges into the turbo-turbine 109, which drives the turbo-compressor 101 to provide a flow of low-boost-air into the central compressor 130, thereby recovering the kinetic energy of the expelled cold-expansion-medium in the most efficiency way.

In FIG. 1A, each cold-expansion-chamber 120 will perform in a Simplified Mackay Four-Stroke Cycle, which takes 720 degree of crankshaft rotation for completing one cycle, and this cycle consists of six processes, which are the first-intake-process (FIG. 1B), the compression-process (FIG. 1C) the hot-combustion-process (FIG. 1D), the second-intake-process (FIG. 1E), the cold-expansion-process (FIG. 1F), and the exhaust-process (FIG. 1G); Process Chart.2 is a reference of the chamber condition for the medium load operation of the MFES, wherein FIG. 1B represents the chamber condition at 30 degree of crankshaft reference angle, FIG. 1C represents the chamber condition at 240 degree of crankshaft reference angle, FIG. 1D represents the chamber condition at 350 degree of crankshaft reference angle, FIG. 1E represents the chamber condition at 410 degree of crankshaft reference angle, FIG. 1F represent the chamber condition at 435 degree of crankshaft reference angle, and FIG. 1G represent the chamber condition at 570 degree of crankshaft reference angle.

It should be noted that the starting point and the length of each process will vary according to the operation condition of the MFES, FIG. 1B-1G only demonstrates the possible chamber condition in a medium load operation; for example, the cold-expansion-process is starting at 430 degree of crankshaft reference angle when the second-intake-process is performed from 400 degree to 430 degree of crankshaft reference angle in a light load operation, while the cold-expansion-process is starting at 460 degree of crankshaft reference angle when the second-intake-process is performed from 440 degree to 460 degree of crankshaft reference angle in a extremely heavy load operation; further details are provided in the process charts.

During an engine idling operation or a brake operation, the power-management-unit will command the engine components of the MFES to operate in an energy-saving mode, wherein the actuation of the reenergize-air-injectors are disabled, so that the second-intake-process and the cold-expansion-process are disabled to keep the cold-expansion-chambers hot by heating with the hot-combustion-medium during the entire down-stroke, thereby reserving the heat energy in the cold-expansion-chambers; this prevents the cold-expansion-chambers to be cooled down during the idling operation or the brake operation for a better overall fuel efficiency in the city traffics.

The first-intake-process (FIG. 1B) is the process to supply an air and a fuel into the cold-expansion-chamber before the piston 122 reaches the associated TDC position (0 degree of crankshaft reference angle); during this process, the air-intake-valve 172 will be actuated to supply an air into the cold-expansion-chamber, the fuel can be supplied by a fuel-injector or a carburetor so that the fuel is also supplied into the cold-expansion-chamber during the first-intake-process; the first-intake-process should be commenced within the range of 0 degree to 270 degree of crankshaft reference angle; for the medium operation as shown in Process Chart.2, the first-intake-process is commenced from 0 degree to 195 degree of crankshaft reference angle.

The compression-process (FIG. 1C) is a process to compress the air and the fuel in the cold-expansion-chamber 120 to form an air-fuel-mixture before the piston 122 reaches the associated TDC position (360 degree of crankshaft reference angle); for an MFES equipped with an internal fuel-injector (or the commonly known direct-fuel-injector) in the cold-expansion-chambers, the fuel may be supplied during the compression-process; the compression-process should be commenced within the range of 180 degree to 360 degree of crankshaft reference angle; for the medium load operation as shown in Process Chart.2, the compression-process is commenced from 195 degree to 350 degree of crankshaft reference angle; for the best efficiency, the air-fuel ratio of the air-fuel-mixture should be stoic or lower than stoic (fuel-rich ratio), so that the air-fuel-mixture is combusted in a fuel-rich condition during the hot-combustion-process.

The hot-combustion-process (FIG. 1D) is a process to ignite said air-fuel-mixture with the associated spark-plugs 180, thereby forming a hot-combustion-medium in the cold-expansion-chamber 120; the hot-combustion-medium will combust most of the oxygen-gas of said air-fuel-mixture into a carbon-monoxide-gas; wherein the hot-combustion-medium is producing power at a temperature of 2500-1400 degree Celsius during the hot-combustion-process, so the carbon-monoxide-gas cannot be converted into a carbon-dioxide-gas due to the high temperature condition and the low oxygen-gas concentration in the hot-combustion-medium; the hot-combustion-process should be commenced within the range of 330 degree to 435 degree of crankshaft reference angle; for the medium load operation as shown in Process Chart.2, the hot-combustion-process is commenced from 350 degree to 420 degree of crankshaft reference angle.

The second-intake-process (FIG. 1E) is a process to inject a programmed amount of high-boost-air into the cold-expansion-chamber 120 with the reenergize-air-injector 177 at a precisely controlled timing, wherein the reenergize-air-injector is actuated at a time after the medium pressure of the hot-combustion-medium has decreased to lower than the operation pressure of the reenergize-buffer 155, and the reenergize-air-injector is opened for a controlled duration, which regulates the amount of said high-boost-air being injected during the second-intake-process, such that the temperature of the hot-combustion-medium is reduced by 30%-80% by the end of the second-intake-process; wherein the hot-combustion-medium is mixed with said injected high-boost-air to form an oxygen-rich cold-expansion-medium at a temperature lower than 1100 degree Celsius; the second-intake-process should be commenced in the range of 400 degree to 460 degree of crankshaft reference angle; for the medium load operation shown in Process Chart.2, the second-intake-process is commenced from 420 degree to 435 degree of crankshaft reference angle.

The air mass of the injected high-boost-air in the second-intake-process will be at least 50% of the air mass of the inhaled air in the first-intake-process for a regular operation of the Simplified Mackay Four-Stroke Cycle; in the case where the MFES is equipped with a highly-efficient air-compression-means for supplying the high-boost-air, the air mass of the injected high-boost-air in the second-intake-process can be as high as 250% of the air-mass of the inhaled air in the first-intake-process for maximizing the expansion efficiency in the cold-expansion-process; by injecting a higher amount of high-boost-air in the second-intake-process, the conversion of carbon-dioxide-gas will be completed in a shorter reaction time, which allows more thermal energy to be converted to expansion force during the cold-expansion-process.

Another remarkable effect of the MFES is that, the cold-expansion-medium expands at a much lower temperature than the conventional engine does, so that the heat energy dissipating into the engine cooling system (the radiator) is reduced by half or more, so that a much higher fraction of thermal energy is reserved to raise the expansion pressure of the cold-expansion-medium during the cold-expansion-process.

The cold-expansion-process (FIG. 1F) is a process to efficiently produce power with the cold-expansion-medium in the cold-expansion-chamber 120; during the cold-expansion-process, the cold-expansion-medium will expand with a slowly-decreasing expansion pressure in a low-temperature oxygen-rich condition, wherein a conversion from carbon-monoxide-gas to carbon-dioxide-gas is accelerated to release more thermal energy, which in terms increases the expansion force, therefore the expansion pressure of the cold-expansion-medium is declined at a much slower rate than the expansion pressure of the conventional engine; in a heavy load with a very rich air-fuel-mixture, any existing fuel-gas is also combusted almost spontaneously into carbon-dioxide-gas during the cold-expansion-process because of the low-temperature oxygen-rich environment; in addition the heat-current conducting from the cold-expansion-medium into the engine cooling system (the radiator) is also minimized because of the low temperature difference between the cold-expansion-chamber 120 and the cold-expansion-medium, in other words, the cold-expansion-medium is continuously releasing the thermal energy from said accelerated conversion at low temperature, and the cold-expansion-medium dissipates very little heat energy out of the cold-expansion-chamber 120, so that the energy of the injected fuel is fully released in an energy-efficient way before the cold-expansion-medium is expelled out of the cold-expansion-chamber 120; the cold-expansion-process should be commenced within the range of 405 degree to 540 degree of crankshaft reference angle; for the medium load operation shown in Process Chart.2, the cold-expansion-process is commenced from 435 degree to 535 degree of crankshaft reference angle.

The exhaust-process (FIG. 1G) is a process to expel the cold-expansion-medium with the exhaust-valve; the exhaust-process should be commenced within the range of 480 degree to 720 degree of crankshaft reference angle, wherein the starting point of the exhaust-process should be adjusted to minimize the pumping loss while keeping enough effective duration of the cold-expansion-process for producing power; for the medium load operation as shown in Process Chart.2, the exhaust-process is commenced from 535 degree to 720 degree of crankshaft reference angle.

As a supplementary note for the range of the exhaust-process; when the MFES is operating at a very high rpm, it may be necessary to set an earlier starting point of the exhaust-process, such that the exhaust-valve is actuated from 480 degree to 720 degree of crankshaft reference angle, which allows momentum of the cold-expansion-medium to change, thereby reducing the pumping loss; however, for the best efficiency, the exhaust-process will generally starts at a point between 510 degree and 540 degree of crankshaft reference angle, which also requires collaboration with a variable-valve-timing mechanisms for the exhaust-valve like a conventional engine, and the valve timing scheme of the MFES is significantly different from that of a conventional engine due to the slowly-decreasing expansion pressure in the cold-expansion-process.

In comparison to the convention engine, the cold-expansion-process of MFES produce power with a relatively stable expansion pressure and an accelerated conversion of the carbon dioxide gas at a low temperature regulated in the range of 400-1100 degree Celsius; whereas the expansion stroke of the conventional engine progresses a high peak pressure and a rapid pressure decline, and the conversion of the carbon-monoxide-gas to the carbon-dioxide-gas generally takes place only in the catalytic converter or the exhaust tail-pipe, this is because that the combustion-medium of the conventional engine is expanding in a high temperature (1400-2500 degree Celsius) condition, so the conversion of carbon-monoxide-gas to carbon-dioxide-gas only occurs in the exhaust pipe in the standard operation condition, which causes a unnecessary energy loss by dissipating a massive heat energy into the atmospheric air.

The average expansion temperature of the Simplified Mackay Four-Stroke Cycle is at least 50% lower than the average expansion temperature of the conventional engine when comparing a MFES and a conventional engine with the equivalent power output.

The average expansion pressure of the Simplified Mackay Four-Stroke Cycle is at about 30% higher than that of the conventional engine when comparing the maximum power output of a MFES with that of a conventional engine with the equivalent size.

The expelled cold-expansion-medium of the Simplified Mackay Four-Stroke Cycle will have a high oxygen concentration even in the heavy load operation, which is unlike the conventional engine that combusts with a fuel-rich ratio in the heavy load; in other words, even when the hot-combustion-process of the Simplified Mackay Four-Stroke Cycle is being performed with a fuel-rich air-fuel-mixture at an air-fuel ratio such as 9:1 in a heavy load operation, the cold-expansion-medium is still expanding with an excessive oxygen-gas concentration during the cold-expansion-process, thereby creating a low-temperature oxygen-rich condition that accelerates the conversion of the carbon-dioxide-gas, and the exhaust gas will still contains excessive oxygen-gas even after all the fuel has combusted into the carbon-dioxide-gas; it should be understood that it is a clear indication of malfunction if the exhaust gas of the MFES contains no oxygen-gas in the heavy load operation or the medium load operation.

To further explain the effect of the cold-expansion-process of the Simplified Mackay Four-Stroke Cycle, it is necessary to first identity an optimized expansion process of the internal combustion engine, (this should not to be confused with the theoretically expansion process defined by the ideal gas law and the adiabatic expansion process).

The optimized expansion process should be an expansion process that can convert as much energy as physically possible into expansion force at a gradual rate (this is a totally opposite concept of the commonly known HCCI engine), meanwhile preventing the heat energy from dissipating into the atmospheric air or the engine cooling system (the radiator); in order to achieve this optimized expansion process, first of all, the heat current conducting out of the combustion chamber should be minimized, secondly the expansion pressure should be steady and constant through out entire expansion process, thirdly all the available reaction energy (which is the total energy released until the carbon content of a fuel is completely converted into carbon-dioxide-gas) should be completely converted into the expansion force before the completion of the power-stroke (the 3rd-Stroke in a four-stroke engine), fourthly the compression energy consumed by the air-compression process should be regulated for keeping a high energy-efficiency, and fifthly this expansion process should not produce any soot or pollutant material.

In the conventional spark-ignition four-stroke engine, more than ⅓ of the total reaction energy is dissipated into the engine cooling system, and another ⅓ of the total reaction energy is dissipated into the air with the exhaust-gas, leaving merely less than 30% of the total reaction energy to be converted into the expansion force; this is because the expansion-process of the conventional four-stroke engine will have an expansion temperature of 1400 degree Celsius or much higher from the beginning of the power-stroke to the end of the exhaust-stroke, in plain words, this is equivalent to heating up the combustion-chamber at 1400 degree Celsius from the beginning of the power-stroke to the end of the exhaust-stroke; the second reason of this energy-loss is the delayed conversion of the carbon-monoxide-gas to carbon-dioxide-gas, which means that most of the thermal energy released by said delayed conversion of carbon-dioxide-gas is heating up the exhaust-gas in the exhaust-tailpipe, this is because the carbon-monoxide-gas can hardly react with oxygen to form the carbon-dioxide-gas at high temperature with low oxygen concentration, so most of the carbon-dioxide-gas is formed after the combustion medium has left the combustion chamber into the exhaust-tailpipe, where the combustion-medium can be cooled to reduce its temperature to 1100 degree Celsius or lower by dissipating a massive portion of the total fuel energy into the atmospheric.

The main purpose of the Simplified Mackay Four-Stroke Cycle is to perform the expansion process as close to the previously defined optimized expansion process as physically possible; even though the second condition states that the expansion pressure should be steady and constant during the power-stroke, which is considered difficult to accomplished, but the Simplified Mackay Four-Stroke Cycle approaches this objective by breaking down the regular combustion reaction into a hot-combustion-process and a cold-expansion-process for releasing the fuel energy at a controlled and gradual rate; wherein, the hot-combustion-process will release a portion of the fuel energy by igniting a fuel-rich air-fuel-mixture to form a hot-combustion-medium of high carbon-monoxide-gas concentration, and the cold-expansion-process will completely release the rest of the fuel energy by a sudden increase of oxygen-gas concentration and a cooling effect that blocks the heat dissipation; the ignition of the fuel-rich air-fuel-mixture of the hot-combustion-process results in a relatively slow release of the fuel energy than a lean air-fuel-mixture, so this hot-combustion-process will be performing with a relatively lower peak temperature than the conventional lean-burn engine, this minimizes the heat loss through the chamber head during the earlier portion of the power-stroke; the programmed injection of high-boost-air of the second-intake-process will raise the oxygen-gas concentration and have a cooling effect on said hot-combustion-medium, which satisfies the abovementioned conditions of the optimized expansion-process that demands the least possible heat dissipation and a complete conversion of the carbon-dioxide-gas during the power-stroke.

In the actual operation of the MFES, the average expansion temperature of the entire power-stroke is reduced to less than half of the expansion temperature of the conventional engine, and a cold-expansion-medium will produce power by fully releasing the energy of the injected fuel with the least possible heat loss during the power-stroke (the 3rd-Stroke), wherein the conversion of carbon-monoxide-gas to carbon-dioxide-gas occurs spontaneously due to the low-temperature oxygen-rich environment; furthermore, in order for the Simplified Mackay Four-Stroke Cycle to achieve the optimal expansion efficiency, it is also necessary for the power-management-unit to adjust the operation speed of the air-compression means and the actuation time of the reenergize-air-injector according to the operation condition of the MFES.

Now referring to Process Chart.1, Process Chart.2, and Process Chart.3 for explaining the control methods of the MFES shown in FIG. 1A; wherein each process chart represents a different operation condition of MFES, it should be noted that the exemplary actuation times of each valve or reenergize-air-injector are only set for the demonstration purpose, and these values are not to be considered as limitation elements of the present invention:

Process Chart.1 shows an example of the Simplified Mackay Four-Stroke Cycle in a light load operation; wherein the air-intake-valve is being opened from 0 degree to 210 degree of crankshaft reference angle to perform the first-intake-process; the piston compresses the air and the fuel in the cold-expansion-chamber from 210 degree to 345 degree of crankshaft reference angle to perform the compression-process; the spark-plug ignites and combusts an air-fuel-mixture as a hot-combustion-medium from 345 degree to 400 degree of crankshaft reference angle to perform the hot-combustion-process; the reenergize-air-injector is being actuated to injected high-boost-air into the cold-expansion-chamber to perform the second-intake-process from 400 degree to 420 degree of crankshaft reference angle; an cold-expansion-medium is producing power in the cold-expansion-chamber from 420 degree to 540 degree of crankshaft reference angle to perform the cold-expansion-process; the exhaust-valve is being actuated to expel the cold-expansion-medium out of the cold-expansion-chamber from 540 degree to 720 degree of crankshaft reference angle to perform the exhaust-process.

Process Chart.2 shows an example of the Simplified Mackay Four-Stroke Cycle in a medium load operation; wherein the air-intake-valve is being opened from 0 degree to 195 degree of crankshaft reference angle to perform the first-intake-process; the piston compresses the air and the fuel in the cold-expansion-chamber from 195 degree to 350 degree of crankshaft reference angle to perform the compression-process; the spark-plug ignites and combusts an air-fuel-mixture as a hot-combustion-medium from 350 degree to 420 degree of crankshaft reference angle to perform the hot-combustion-process; the reenergize-air-injector is being actuated to injected high-boost-air into the cold-expansion-chamber to perform the second-intake-process from 420 degree to 435 degree of crankshaft reference angle; an cold-expansion-medium is producing power in the cold-expansion-chamber from 435 degree to 535 degree of crankshaft reference angle to perform the cold-expansion-process; the exhaust-valve is being actuated to expel the cold-expansion-medium out of the cold-expansion-chamber from 535 degree to 720 degree of crankshaft reference angle to perform the exhaust-process.

Process Chart.3 shows an example of the Simplified Mackay Four-Stroke Cycle in a heavy load operation; wherein the air-intake-valve is being opened from 0 degree to 180 degree of crankshaft reference angle to perform the first-intake-process; the piston compresses the air and the fuel in the cold-expansion-chamber from 180 degree to 355 degree of crankshaft reference angle to perform the compression-process; the spark-plug ignites and combusts an air-fuel-mixture as a hot-combustion-medium from 355 degree to 430 degree of crankshaft reference angle to perform the hot-combustion-process; the reenergize-air-injector is being actuated to injected high-boost-air into the cold-expansion-chamber to perform the second-intake-process from 430 degree to 450 degree of crankshaft reference angle; an cold-expansion-medium is producing power in the cold-expansion-chamber from 450 degree to 530 degree of crankshaft reference angle to perform the cold-expansion-process; the exhaust-valve is being actuated to expel the cold-expansion-medium out of the cold-expansion-chamber from 530 degree to 720 degree of crankshaft reference angle to perform the exhaust-process.

From the above description, it can be seen that the starting point of the second-intake-process may vary according to the operation condition of the MFES; this is because the second-intake-process is only started after the pressure of the hot-combustion-medium has decreased to lower than the air-pressure (or the operation pressure) of the reenergize-air, as the pressure of the hot-combustion-medium increases proportionally to an increase in the engine load, therefore, the starting point of the second-intake-process will be shifted to a later (greater) crankshaft reference angle when the hot-combustion-process is commenced with a higher pressure, in contrast, the starting point of the second-intake-process will be shifted to a earlier (smaller) crankshaft reference angle when the hot-combustion-process is commenced with a lower pressure.

The ratio between the air-mass of the inhaled air of the first-intake-process and the air-mass of the injected high-boost-air of second-intake-process should also be adjusted according to the necessary amount of high-boost-air to cool down the hot-combustion-medium for accelerating the conversion of carbon-dioxide-gas and minimizing heat-loss; wherein the temperature of the cold-expansion-medium is to be regulated within the range of 400-1100 degree Celsius during the cold-expansion-process, so that the optimum energy efficiency is achieved while the catalytic converter is still able to function and convert the toxic byproducts of the fuel combustion; this is because that the current commercialized catalytic converters usually have an operable temperature limit designed at about 350-400 degree Celsius; however, a catalytic-converter capable of operation in a relatively lower temperature is more preferable for collaborating with the MFES, since this can further reduce the overall heat loss.

The speed-controlled air-compression means, which is the central-compressor 130 of FIG. 1A, can be a scroll type compressor, a screw-type compressor, a piston type compressor, the centrifugal type compressor, a rotary type compressor, an axial-turbine compressor, or any other conventional air-compressor; however the central-compressor should be one that can operate at high revolution speed to produce a continuous flow at all time with variable airflow speed control, so the reenergize-buffer 177 can have a constant operation pressure regardless of any sudden change in power output, thereby ensuring the functionality of the reenergize-air-injectors.

It is also possible to have two or more central-compressors connecting in parallel with different charging phase to supply the high-boost-air to the reenergize-buffer, and this is one of the solutions to provide a more stabilized operation pressure for the reenergize-buffer if a piston type central-compressor or other low-speed central-compressor is used; this is because a single piston type central-compressor or a low-speed central-compressor cannot generate a constant airflow, for example, a single piston air-compressor usually is only outputting the compressed air during the last 30-60 degree of its crankshaft rotation prior to its TDC position, which leaves a long interval between each charge of compressed air, thereby affecting the control over the injected air-mass of the reenergize-air-injector, or causing a faulty operation of the reenergize-air-injectors; therefore, implementing more than one central-compressor into the MFES is a much more fail-safe design if the operation cost permits.

The compressor-cooler may be an air-cooling type or a refrigeration-cooling type, wherein the air-cooling type compressor-cooler utilizes a flow of ambient air to cool the low-boost-air flown through the compressor-cooler, while the refrigeration-cooling type compressor-cooler utilizes a refrigerant circulation to cools the low boost-air flown through the compressor-cooler.

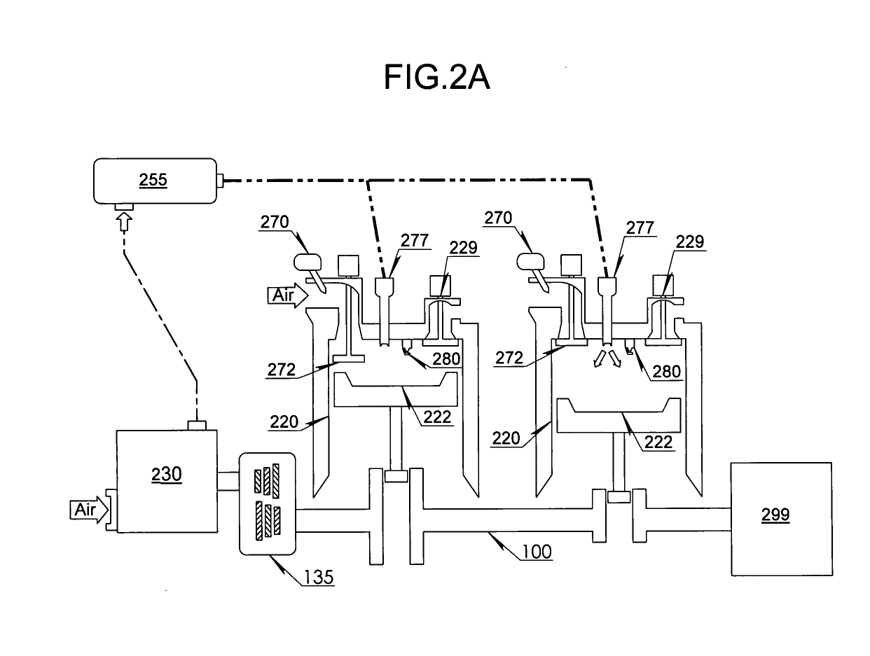

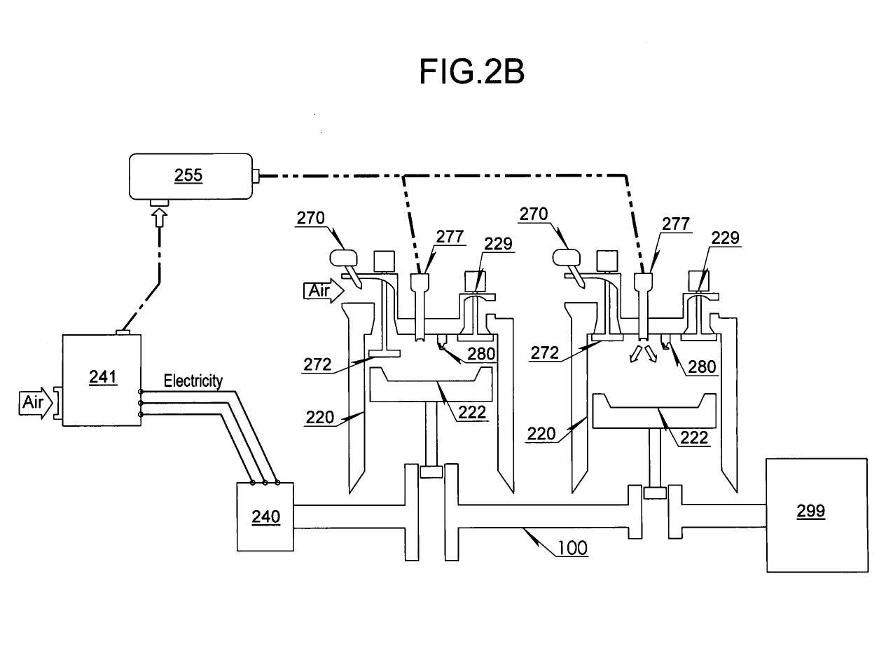

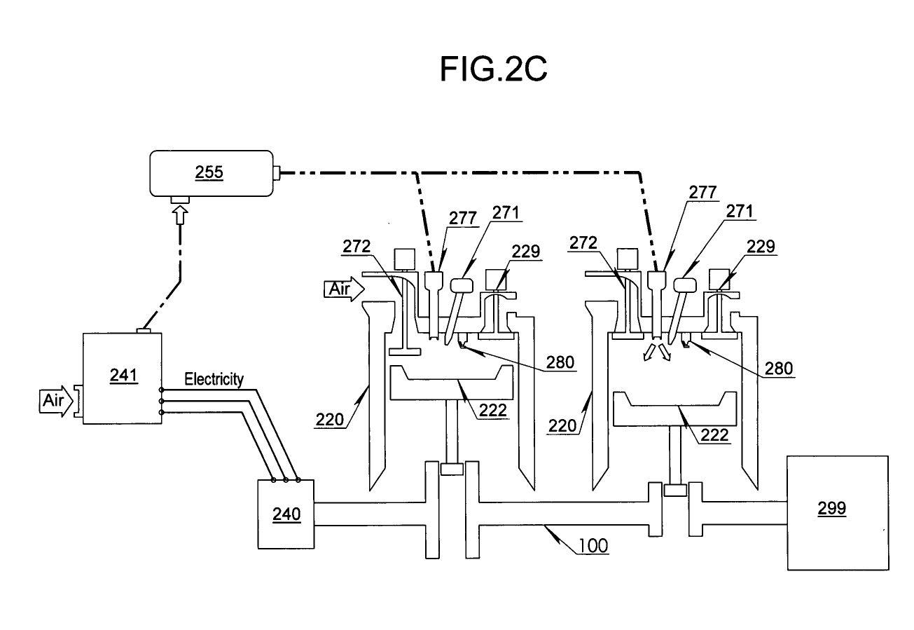

Now referring to FIG. 2A for the second embodiment, this is a basic form of the Mackay Four-Stroke Engine System suitable for uses in the light-weight vehicles, motorcycles, light-duty generator, or small boats, wherein the manufacturing cost of the engine components is the lowest but the overall energy efficiency is still above 25% in the standard operation.

The components in FIG. 2A are labeled as the central-compressor 230, the reenergize-buffer 255, the compressor-transmission 235, the cold-expansion-chambers 220, the fuel-injectors 270 (or a carburetor), the pistons 222, the air-intake-valves 272, the reenergize-air-injectors 277, the exhaust-valves, the spark-plugs 280, the crankshaft 200 and the output shaft 299.

The central-compressor 230 generates a flow of high-boost-air to the reenergize-buffer 255.

The reenergize-buffer 255 will buffer a high-boost-air to the reenergize-air-injectors 277 at an air-pressure set by the power-management-unit in the range of 4-25 bar gauge, wherein said air-pressure (also refers as the operation pressure of the reenergize-buffer) will be maintained within a programmed range by varying the operation speed of the compressor-transmission 235.

The compression-transmission 235 is controlled by the power-management-unit to maintain the operation pressure of the reenergize-buffer 255, wherein the compression-transmission 235 adjusts its gear setting to change the operation speed of the central-compressor 230 in such a way that, the airflow speed in the reenergize-buffer will be increased proportionally to a increase in the engine power output while the air-pressure in the reenergize-buffer 255 remains almost constant.

For the ease of comprehension and the demonstration purpose, the assumptions of the pressure values and temperature values during a medium load operation are made and stated as follows: the reenergize-buffer is set to have an operation pressure of 12 bar, and the high-boost-air has a temperature of about 50-200 degree Celsius, the air-intake-valves takes in the ambient air at about atmospheric temperature, the average temperature of the expelled cold-expansion-medium (or the exhaust-gas) is at about 400-550 degree Celsius.

Each cold-expansion-chamber 220 will operate in the Simplified Mackay Four-Stroke Cycle consisting of six processes, which are the first-intake-process, the compression-process, the hot-combustion-process, the second-intake-process, the cold-expansion-process, and the exhaust-process.

During an engine idling operation or a brake operation, the power-management-unit will command the MFES to operate in an energy-saving mode, wherein the actuation of the reenergize-air-injectors is disabled, so the second-intake-process and the cold-expansion-process are disabled to keep the cold-expansion-chambers hot by heating with the hot-combustion-medium during the entire down-stroke.

The process sequence of the second embodiment is the same as in the previously mentioned process sequence shown in the first embodiment, and which are explained with Process Chart.1-3 for demonstrating the possible changes to the process durations of the Simplified Mackay Four-Stroke Cycle in response to the changes in the engine load condition.

The first-intake-process is performed by actuating the air-intake-valve to inhale a flow of ambient air and a fuel at an air-fuel ratio that is equal to or lower than the stoic ratio, so that a stoic air-fuel-mixture or a fuel-rich air-fuel-mixture is formed in the cold-expansion-chamber, wherein the first-intake-process should be commenced in the range of 0 degree to 270 degree of crankshaft reference angle, the actuation of the air-intake-valve should be performed with a variable-valve-mechanism for the best efficiency.

The compression-process is performed by compressing the ambient air and the fuel with the associated piston in the cold-expansion-chamber, wherein the compression-intake-process should be commenced in the range of 180 degree to 360 degree of crankshaft reference angle, and the effective length of the compression-process is controlled by the actuation time of the first-intake-valve and the ignition timing of the spark-plug.

The hot-combustion-process is performed by igniting an stoic air-fuel-mixture or a fuel-rich air-fuel-mixture as a hot-combustion-medium in the cold-expansion-medium, wherein the starting point of the hot-combustion-process may range from 325 degree to 390 degree of crankshaft reference angle; this starting point of the hot-combustion-process is basically depending on the ratio between the piston revolution speed and the flame front speed, as in the high speed operation, the ignition is started as earlier as 325 degree of crankshaft reference angle since the piston is moving at a relatively much higher speed, whereas the ignition is started as close as to the TDC in the low rpm operation since there is enough time for the flame front to travel; it should be noted that the optimized ignition timing scheme of the MFES is quite different from the regular four-stroke engine, since there is no second-intake-process involved in the down-stroke of the conventional engine, this means that the injected air-mass of the second-intake-process and the starting point of the second-intake-process must be taken into the account for designing an optimized ignition timing scheme.

The possible range of the hot-combustion-process is from 325 degree to 435 degree of crankshaft reference angle if the MFES is not operating in the abovementioned energy saving mode; wherein the starting point of the hot-combustion-process is also the ignition time of the ignition means, while the end point of the hot-combustion-process is the starting point of the actuation time of the reenergize-air-injector.

During the hot-combustion-process, most of the carbon content in the compressed air-fuel-mixture is combusted to a carbon-monoxide-gas in said hot-combustion-medium, but the carbon-monoxide-gas cannot be converted into a carbon-dioxide-gas due to the high-temperature oxygen-depleted environment inside the cold-expansion-chamber; however, as the hot-combustion-process progress with a downward motion of the associated piston, the pressure of the hot-combustion-medium will decrease to a point that is lower than the air-pressure (the operation pressure) of the reenergize-buffer, at this point, the second-intake-process is initiated by actuating the reenergize-air-injector to inject a controlled amount of high-boost-air to mix with the hot-combustion-medium.

The second-intake-process is performed by injecting a controlled amount of high-boost-air to mix with said hot-combustion-medium, this injection of high-boost-air must be commenced after the pressure of said hot-combustion-medium has decreased to lower than the operation pressure of the reenergize-buffer; and the possible range of the second-intake-process is from 400 degree to 460 degree of crankshaft reference angle (which can also be converted as 40 degree to 100 degree after the TDC); the air-mass of the high-boost-air being injected by the reenergize-air-injector should be at least 50% of the air inhaled in the first-intake-process, and the temperature of the hot-combustion-medium will be reduced by 30%-80% by the end of the second-intake-process, thereby the expansion temperature is kept below 1100 degree Celsius during the cold-expansion-process.

The possible range of the second-intake-process is basically depending on the pressure decline rate of the hot-combustion-medium during the hot-combustion-process, which means that the compression ratio of the cold-expansion-chamber is also one of the factor that should be taken into account for designing the actuation timing scheme of the power-management-unit; another supplementary note on the range of the second-intake-process, as the engine load (or the power output) increases, which requires an increase in the average combustion pressure during the hot-combustion-process, so the second-intake-process is initiated at a later (greater) crankshaft reference angle if there is an increase in the engine load (power output); the ratio between the injected air-mass of the high-boost-air in the second-intake-process and the inhaled air-mass of the ambient air in the first-intake-process will also be adjusted accordingly in order to form the cold-expansion-medium within 400-1100 degree Celsius.

The actuation mechanisms of the reenergize-air-injector can be a solenoid mechanism, a servo-motor mechanism, a hydraulic-actuated mechanism, a cam-driven variable-timing-mechanism, or any other conventional valves capable of shifting the actuation timings according to the command from the power-management-unit; one of the most inexpensive method for building a reenergize-air-injector is to use a combination of a spring mechanism and a servo-mechanism, wherein the spring mechanism will only effect the air-passage of the reenergize-air-injector after the medium pressure of the hot-combustion-medium is lower than the operation pressure of reenergize-air-injector, and the servo-mechanism limits the open time of the air-passage; another alternative structure is to substitute said servo-mechanism with a cam-driven variable-timing mechanism; another simple solution is by a power-management-unit carefully programmed with the exact timings of the pressure threshold point that the hot-combustion-medium has decreased to lower than the operation pressure of the reenergize-buffer, so that the reenergize-air-injector is only opened for a predetermined timing between 400 degree and 460 degree of crankshaft reference angle, thereby injecting a controlled amount of high-boost-air enough to cool the hot-combustion-medium to lower than 1100 degree Celsius by the end of the second-intake-process.

The control over the injected amount of high-boost-air in the second-intake-process is also crucial to the energy-efficiency; in the case that the excessive high-boost-air is injected during the second-intake-process, the workload on the speed-controlled air-compression means will increase and cause a drop in the overall energy efficiency, and the temperature of the expelled cold-expansion-medium may be lower than the operable temperature of the catalytic converter, which causes an undesired air pollution; whereas, in the case that an insufficient high-boost-air is injected during the second-intake-process, the cold-expansion-process will be inefficient, so the conversion of carbon-monoxide-gas to carbon-dioxide-gas will not be completed during the cold-expansion-process, and the cold-expansion-medium will be conducting excessive heat current to the engine cooling system during both the cold-expansion-process and the exhaust-process, which causes a significant drop in the overall energy efficiency.

The cold-expansion-process is performed by producing power with said cold-expansion-medium in the cold-expansion-chamber; prior to the cold-expansion-process, the temperature of the hot-combustion-medium is reduced down by 30%-80%, by mixing with said controlled amount of the high-boost-air, thereby forming the cold-expansion-medium at a low-temperature and high-oxygen-concentration condition that is ideal for generating power, wherein the temperature of said cold-expansion-medium is regulated within the range of 400-1100 degree Celsius during the cold-expansion-process for accelerating the conversion of carbon-monoxide-gas to carbon-dioxide-gas, and this low temperature characteristic of the cold-expansion-medium will also prevent the heat energy to dissipate throughout the chamber wall of the cold-expansion-chamber 220.

The possible range of the cold-expansion-process is from 435 degree to 540 degree of crankshaft reference angle, wherein the starting point of the cold-expansion-process is the end point of the actuation time of the reenergize-air-injector, and the end point of the cold-expansion-process is the starting point of the actuation time of the exhaust-valve.

The exhaust-process is performed by expelling the cold-expansion-medium with the exhaust-valve 229; wherein the exhaust-valve 229 may be a cam-driven variable-timing-valve, a servo-motor-valve, a hydraulic-valve or a solenoid-valve; and the power-management-unit should also adjust the actuation time of the exhaust-valve according to the engine load condition and the engine rpm, wherein the possible range of the exhaust-process is from 480 degree to 720 degree of crankshaft reference angle.

Unlike other engine system, in order to program an optimized control scheme for the MFES, the power-management-unit needs to further take in the factors of the pressure of the cold-expansion-medium, the temperature of the cold-expansion-medium, the compression energy consumed by the speed-controlled air-compression means, the heat-current conducted out of the cold-expansion-chambers (which can be measure by the a temperature sensor embedded in the cold-expansion-chamber or the engine cooling circulation), and the oxygen concentration in the expelled cold-expansion-medium.

One of the major difference between a MFES and a conventional engine is that the MFES will expel a cold-expansion-medium with a high oxygen concentration even in a high power output operation; if the oxygen sensor at the exhaust manifold of a cold-expansion-chamber detects no oxygen gas, it would be an obvious indication that the amount of the high-boost-air injected in the second-intake-process is incorrect and requires adjustment to some of the component settings of the MFES.

Now referring to FIG. 2B for the alternative structure of the basic form of the present invention, which includes a speed-controlled air-compressor driven by a compressor-motor, wherein the compressor-motor is powered by an inverter system to operate at a controlled speed requested by the power-management-unit, and said inverter system takes power from the crankshaft of the cold-expansion-chambers with an alternator; the power-management-unit includes a reenergize-buffer-sensor for taking in the airflow data (pressure/airflow mass/temperature), which assists the power-management-unit to control the operation speed of the speed-controlled air-compressor for maintaining a predetermined air-pressure (the operation pressure) within the reenergize-buffer, thereby maximizing the overall energy efficiency of the MFES.

To summarize the concept and the effects of the Simplified Mackay Four-Stroke Cycle, the MFES will operate with an extremely low heat loss, which is about 7%-15% of the total fuel energy, wherein the temperature of the expelled cold-expansion-medium (the exhaust-gas) will be 50% less in comparison to the conventional engine, and the most significant difference is that the MFES performs the earlier portion of the power-stroke in a stoic condition or a rich-burn condition, whereas the later portion of the power-stroke is performed in a low-temperature oxygen-rich condition that allows the oxygen-gas to react spontaneously with the carbon-monoxide-gas to produce more expansion force; whereas the conventional engine dissipates a large portion of the fuel energy in the exhaust tailpipe due to the high expansion temperature and the low oxygen concentration.

The fuel source of a MFES can be gasoline, natural gas, CNG, ethanol, hydrogen, diesel, or any other types of spark-combustible fuel.

The operation pressure of the reenergize-buffer may be adjusted to a higher pressure in response to an increase in the engine load, thereby increasing the airflow speed and initiating the second-intake-process at an earlier crankshaft reference angle; an example is provided as follows: in a light load operation of the MFES as shown in Process Chart.1, the power-management-unit may reset the operation pressure of the reenergize-buffer to 8 bar, therefore, during the actuation time of the reenergize-air-injector from 400 degree to 410 degree of crankshaft reference angle, the pressure in the reenergize-buffer is maintained at 8 bar in the entire duration of the second-intake-process; in a heavy load operation of the MFES as shown in Process Chart.3, the power-management-unit reset the operation pressure of the reenergize-buffer to 12 bar, therefore, during the actuation time of the reenergize-air-injector from 405 degree to 415 degree of crankshaft reference angle, the operation pressure of the reenergize-buffer is maintained at 12 bar in the entire duration of the second-intake-process; this also increases the airflow speed to effect a high-boost-air injection of higher air-mass.

The computation circuit of the power-management-unit may take in the parameters such as the compression efficiency of said air-compressor means, the crankshaft rpm, the spark-ignition timing, the oxygen-gas concentration of the expelled cold-expansion-medium, the airflow data (pressure/airflow-mass/temperature) of the expelled cold-expansion-medium, the airflow data (pressure/airflow-mass/temperature) of the reenergize-buffer, the surge-pressure data (surge pressure during the entire down-stroke), and the chamber temperature data (an indication of the heat-loss), thereby configuring the component settings of the MFES for the optimal energy efficiency.

The air-compression means of the MFES may be a scroll-type air-compressor, a screw-type air-compressor, a rotary-type air-compressor, a piston-type air-compressor, a vane-type air-compressor, an axial-turbine type air-compressor, or a centrifugal-turbine type air-compressor; wherein air-compression means requires to be operate at a controlled speed requested by the power-management-unit of the MFES to sustain the operation pressures in the reenergize-buffer; wherein said air-compression means can be powered by a transmission coupled to the crankshaft of the cold-expansion-chamber or powered by an electrical motor and an inverter-system.

It is also possible to employ a diesel ignition means such as a fuel pump or a direct-fuel-injector that injects diesel into the cold-expansion-chamber at the end of the compression-process; however the air pollution caused by the diesel type internal combustion engine requires many other filter technology that could substantially increase the manufacturing cost and the service cost for the average customers, however, a diesel type Simplified Mackay Four-Stroke Cycle is also explains as follows:

The diesel type Simplified Mackay Four-Stroke Engine System includes the same components as shown in FIG. 2A, except that a diesel ignition means or a diesel injection means will replace the spark-plug in each cold-expansion-chamber; the diesel type Simplified Mackay Four-Stroke Cycle still includes the first-intake-process, the compression-process, the hot-combustion-process, the second-intake-process, the cold-expansion-process, and the exhaust-process; wherein the first-intake-process will then take in only the ambient air, while the diesel ignition means/the diesel injection means will inject diesel into the cold-expansion-chamber at the end of the compression-process, where the compressed air in the cold-expansion-chamber reaches the combustible temperature of the diesel fuel, so the diesel fuel is ignited by the compressed air when it is injected into the cold-expansion-chamber; the diesel fuel and the compressed air are then combusted as a hot-combustion-medium at a temperature of 1400-2500 degree Celsius; next the second-intake-process is initiated to inject a programmed amount of high-boost-air after the pressure of the hot-combustion-medium has decreased to lower than the operation pressure of the reenergize-buffer, thereby forming a cold-expansion-medium at a temperature lower than 1100 degree Celsius; next the cold-expansion-medium expands at a temperature between 400-1100 degree Celsius during the cold-expansion-process to effectively produce power with the accelerated conversion of carbon-dioxide-gas in the low-temperature oxygen-rich condition inside the cold-expansion-chamber; and next the cold-expansion-medium is expelled out of the cold-expansion-chamber with the exhaust-valve.

It is also possible to employ a parallel hybrid power-train or a series hybrid power-train into any of the aforementioned embodiments, such that a regeneration-motor and an inverter-system are equipped to recover energy as electricity from a brake operation or an engine idling operation or a direct battery-recharging for increasing the overall energy efficiency in the public transportation applications; since the hybrid power-train technologies are nowadays common knowledge to those skilled in the arts of the internal combustion engines, the implementation of the hybrid power-train into the Mackay Four-Stroke Engine System will not discussed beyond necessary.

For a MFES equipped with a specialized catalytic converter or a particle filter operating in a heavy load operation, a second fuel injection can be performed after the spark-ignition at about the top-dead-centre position of the 3rd-Stroke to increase the fuel concentration in the hot-combustion-medium during the hot-combustion-process; however, this requires a high pressure fuel injector, and this second fuel-injection must be terminated before the initiation of the second-intake-process.

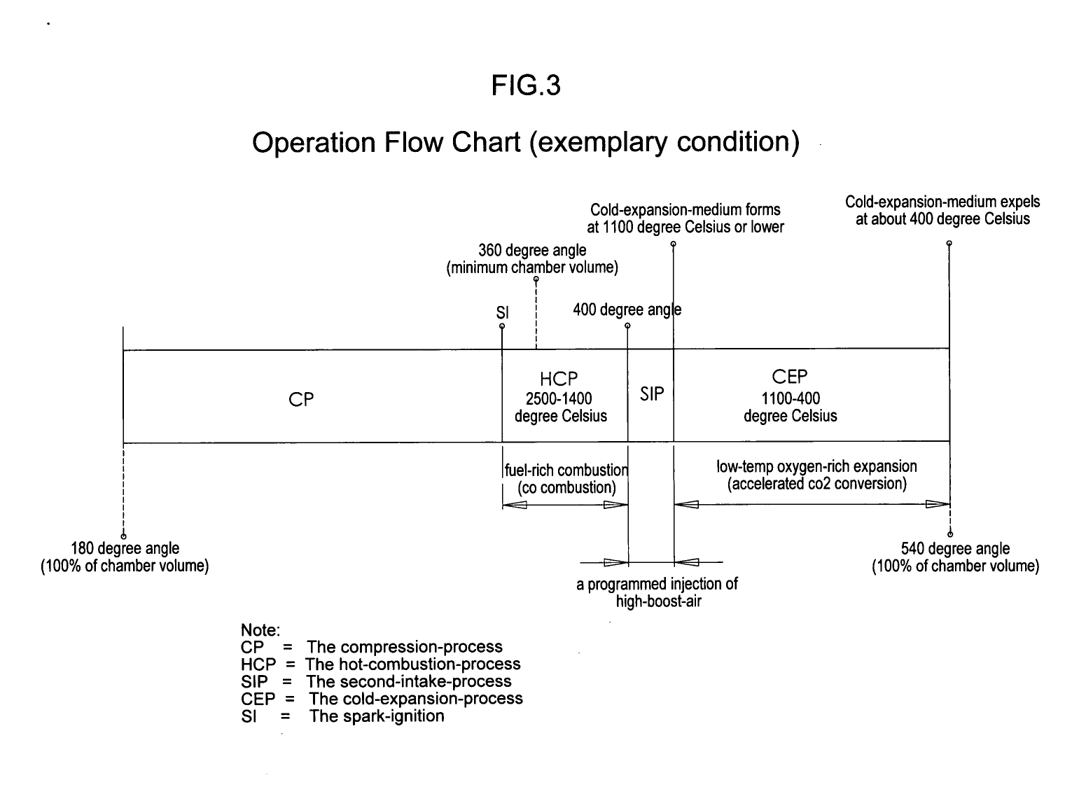

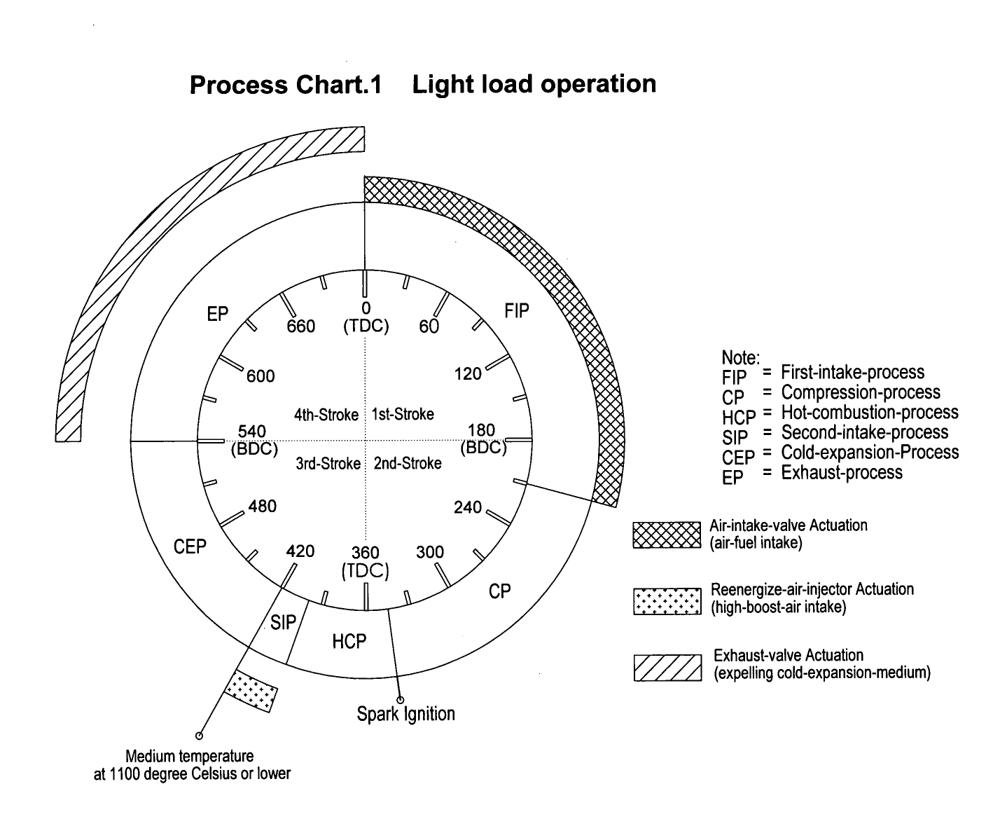

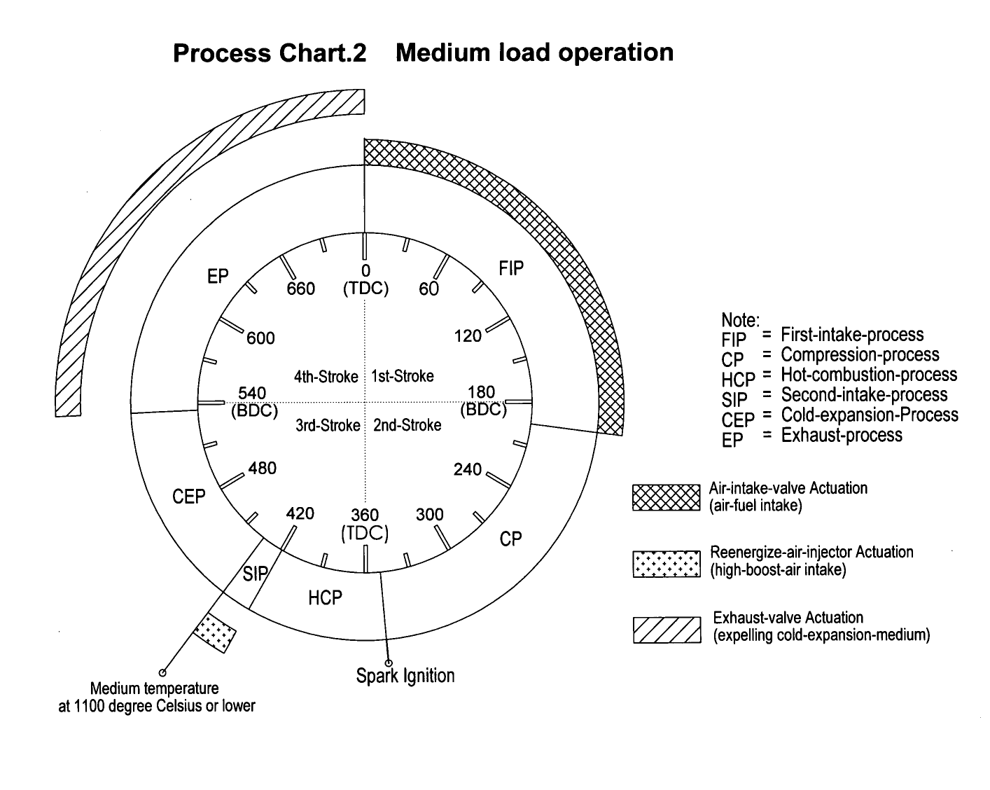

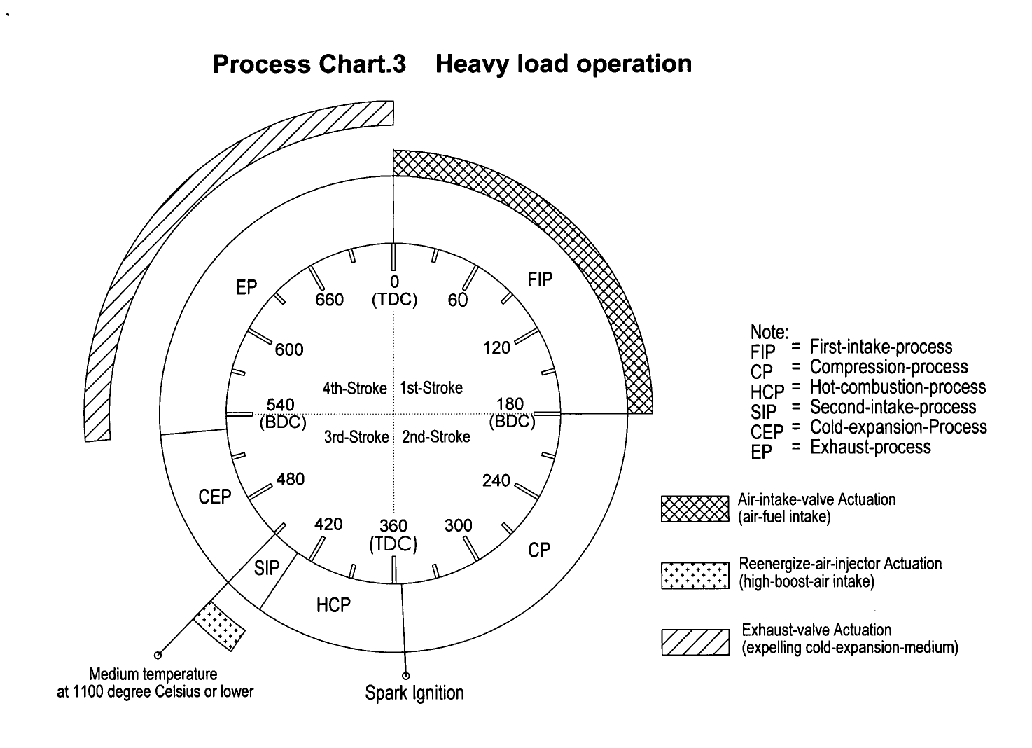

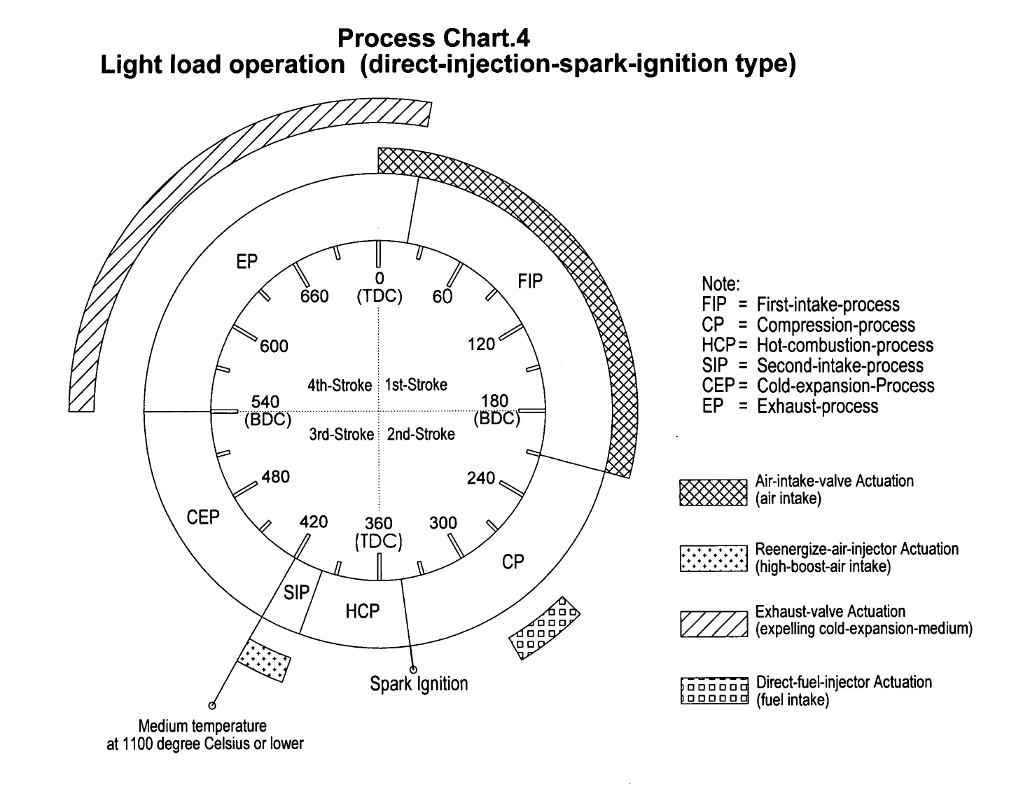

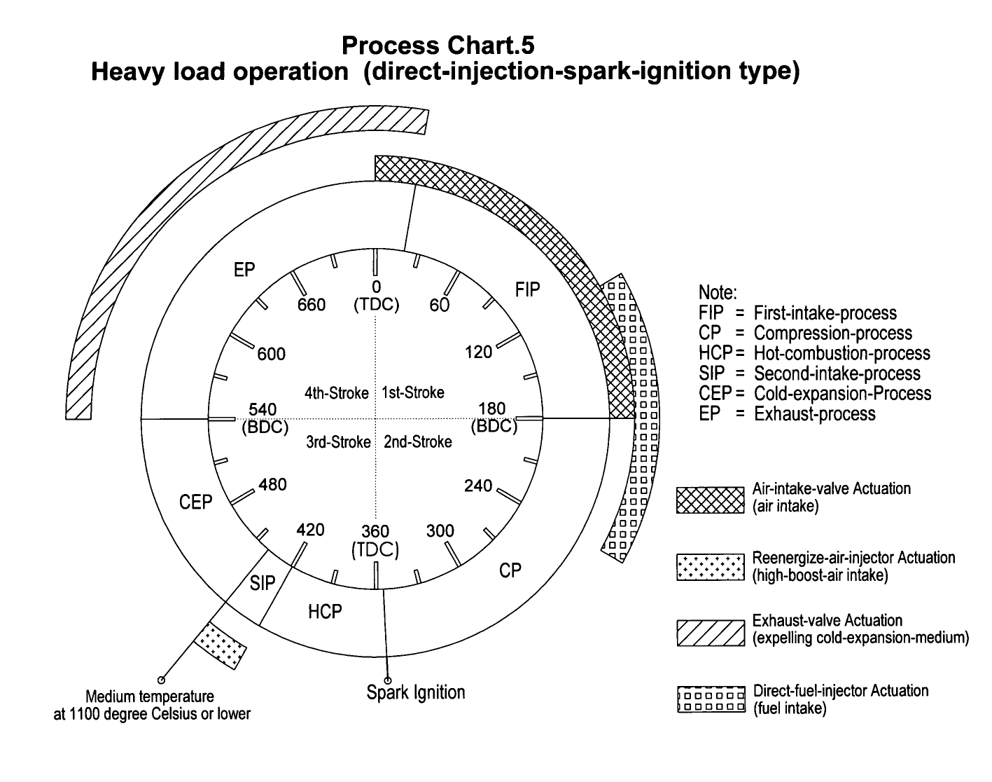

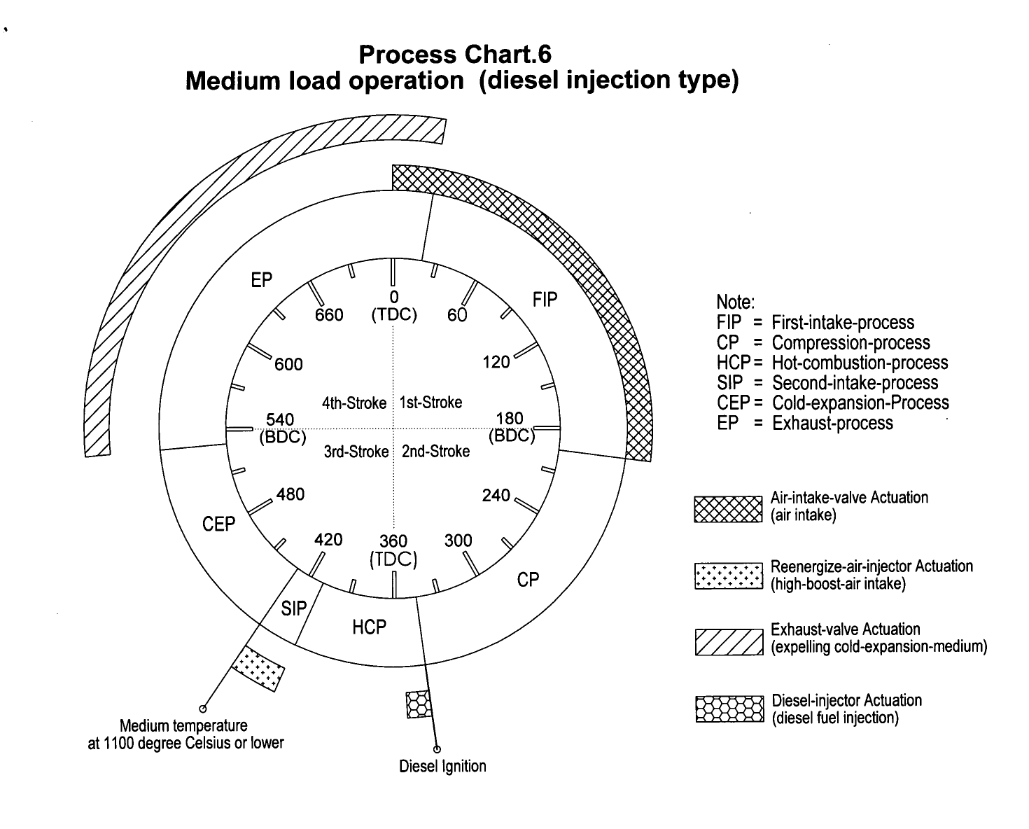

For an easier comprehension of the present invention, an operation flow chart of the 2nd-Stroke to the 3rd-Stroke of the Simplified Mackay Four-Stroke Cycle is provided in FIG. 3; wherein the programmed injection of high-boost-air is only performed at a point when the pressure of the hot-combustion-medium is decreased to lower than the operation pressure of the reenergize-buffer after 400 degree of crankshaft reference angle, thereby forming a cold-expansion-medium at a temperature lower than 1100 degree Celsius.

Many other structures of Mackay Four-Stroke Engine System can also be developed by combining or interchanging the components mentioned in the disclosed embodiments for performing the Simplified Mackay Four-Stroke Cycle; however, constructing a Mackay Four-Stroke Engine System based on the definition by crankshaft reference angle may be difficult for those who are unfamiliar with the concept of optimizing the energy efficiency by comparing the total compression energies consumed and the total expansion-energy being generated by the cold-expansion-process, therefore, in order to provide a more comprehensive definition of Mackay Four-Stroke Engine System (MFES), an alternative definition of Simplified Mackay Four-Stroke Cycle is provided by defining the percentage of the chamber volume in each process, instead of the crankshaft reference angle:

The operation of the Simplified Mackay Four-Stroke Cycle consists of six processes, completed in every 720 degree of crankshaft reference angle (equivalent to two revolution of crankshafts or four strokes), and the six processes are performed in the order of the first-intake-process, the compression-process, the hot-combustion-process, the second-intake-process, the cold-expansion-process, and the exhaust-process; wherein:

The min chamber volume refers to the least possible effective volume inside the cold-expansion-chamber, which is equivalent to the condition at the top-dead-centre position of the piston; the max chamber volume refers to the biggest effective volume inside the cold-expansion-chamber, which is equivalent to the condition at the bottom-dead-centre position of the piston; it should be noted that a cold-expansion-chamber with a configuration of an offset crankshaft may have the min chamber volume at a slightly different position than 0 degree of crankshaft reference angle, which is the reason that the definition by volume percentage is much clear than the definition by crankshaft reference angle.

The first-intake-process and the compression-process are to be completed in the first revolution of crankshaft (0 degree to 360 degree of crankshaft reference angle), wherein a compressed air and a fuel are prepared by these two process for the hot-combustion-process.

The hot-combustion-process is started at about the point when the chamber volume is decreased to a minimum in the 2nd-Stroke (in the case of a 1:10 compression ratio, the minimum is about 10% of the max chamber volume), where said air and fuel are ignited as a hot-combustion-medium that consists of mainly a high temperature combusting carbon-monoxide-gas and a nitrogen-gas, (due to the condition that the temperature of the hot-combustion-medium is about 2500 degree Celsius to 1400 degree Celsius, the formation of carbon-dioxide-gas is not possible at this stage of the operation cycle), and the hot-combustion-process will end at a point between 18% of the max chamber volume and 35% of the max chamber volume.

The second-intake-process is stared at the point (within 18%-35% of the max chamber volume) when the pressure of the hot-combustion-medium decreases to lower than the operation pressure of the reenergize-buffer in the 3rd-Stroke, and the reenergize-air-injector will be actuated for a programmed duration that provides an adequate amount of high-boost-air for reducing the temperature of the hot-combustion-medium by 30%-80% (in order to successively form a cold-expansion-medium for the optimum expansion efficiency, the temperature of the hot-combustion-medium needs to be reduced to lower than 1100 degree Celsius by the end of the second-intake-process, otherwise the thermal energy released by the conversion of the carbon-dioxide-gas will be delayed and wasted as a heat-loss through the engine cooling system); The possible range of the second-intake-process is from 18% of the max chamber volume to 55% of the max chamber volume.

The cold-expansion-process is started at the point (within 25%-55% of the max chamber volume) when a cold-expansion-medium is formed at a temperature lower than 1100 degree Celsius in the 3rd-Stroke; during the cold-expansion-process, the excessive oxygen-gas from previously injected high-boost-air will spontaneously react with the existing carbon-monoxide-gas in the cold-expansion-medium, and the temperature of the cold-expansion-medium is greatly reduced to prevent heat-loss through the chamber wall; the possible range of the cold-expansion-process is from 25%-100% of the max chamber volume.

The exhaust-process is mostly performed during the 4th-Stroke, wherein the variations of the earlier opening of the exhaust-valve or an late closing of the exhaust-valve are possible for better breathing effect or pumping-loss reduction.

In short, the 3rd-Stroke of a Mackay Four-Stroke Cycle will consist at least the followings: a hot-combustion-process commencing from the min chamber volume to at least 18% of the max chamber volume, a second-intake-process commencing within the range of 18%-55% of the max chamber volume, a cold-expansion-process commencing within the range of 25%-100% of the max chamber volume, wherein a programmed amount of high-boost-air is being injected during the second-intake-process to ensure a cold-expansion-medium formed at a temperature lower than 1100 degree Celsius.

The ignition means of the MFES can be a spark-plug, a fuel-injector (direct injection within the chamber), or other types of conventional ignition methods.

Process Chart.4 shows an exemplary Simplified Mackay Four-Stroke Cycle in a light load operation, wherein the MFES is operating with the direction-injection-spark-ignition, a fuel is supplied during the compression-process by a fuel-injection disposed inside each cold-expansion-chamber.

Process Chart.5 shows an exemplary Simplified Mackay Four-Stroke Cycle in a heavy load operation, wherein the MFES is operating with the direction-injection-spark-ignition, a fuel is supplied during both the first-intake-process the compression-process by a fuel-injection disposed inside each cold-expansion-chamber.

Process Chart.6 shows an exemplary diesel type Simplified Mackay Four-Stroke Cycle in a medium load operation, wherein the MFES is operating with the diesel-ignition, a diesel fuel is injected into the cold-expansion-chamber at the end of the compression-process by a diesel fuel pump or a high pressure fuel injector to ignite the compressed air inside the cold-expansion-chamber.

1. A low-cost type Mackay Four-Stroke Engine System comprising:
a) at least two cold-expansion-chambers; wherein, each cold-expansion-chamber includes a piston, a air-intake-valve, a reenergize-air-injector, a fuel-supplying means, a spark-ignition means, and an exhaust-valve for performing a Simplified Mackay Four-Stroke Cycle; wherein each cold-expansion-chamber completes one Simplified Mackay Four-Stroke Cycle in every 720 degree of crankshaft rotation, and the Simplified Mackay Four-Stroke Cycle consists of six processes, which are a first-intake-process, a compression-process, a hot-combustion-process, a second-intake-process, a cold-expansion-process, and an exhaust-process;
b) a power-management-unit for optimizing the expansion efficiency of the cold-expansion-process by controlling the actuation times of the reenergize-air-injectors of said at least two cold-expansion-chambers;
c) a reenergize-buffer for buffering a high-boost-air at a regulated operation pressure to the reenergize-air-injectors of said at least two cold-expansion-chambers, and said operation pressure of the reenergize-buffer is regulated within the range of 4-25 bar gauge;
d) an air-compression means and a compressor-transmission means for providing high-boost-air to said reenergize-buffer; wherein said power-management-unit adjusts the setting of the compressor-transmission means in order to operate said air-compression means at a controlled speed, such that an adequate amount of high-boost-air is supplied to the reenergize-buffer for effecting the second-intake-process of said at least two cold-expansion-chambers; and
e) each cold-expansion-chamber performs the Simplified Mackay Four-Stroke Cycle in the order of the first-intake-process, the compression-process, the hot-combustion-process, the second-intake-process, the cold-expansion-process, and the exhaust-process, wherein:
the first-intake-process and the compression-process are performed within the range between 0 degree of crankshaft reference angle and 360 degree of crankshaft reference angle, wherein an air-fuel-mixture is supplied into the cold-expansion-chamber and compressed with the associated piston;
the hot-combustion-process is performed within the range between 325 degree of crankshaft reference angle and 435 degree of crankshaft reference angle; during the hot-combustion-process, said compressed air-fuel-mixture is ignited with the associated spark-ignition means as a hot-combustion-medium at a temperature between 2500 degree Celsius and 1400 degree Celsius;
the second-intake-process is initiated after the pressure of the hot-combustion-medium has decreased to lower than the operation pressure of the reenergize-buffer, and the second-intake-process is performed within the range between 400 degree of crankshaft reference angle and 460 degree of crankshaft reference angle; during the second-intake-process, a programmed amount of high-boost-air is injected into the cold-expansion-chamber by the associated reenergize-air-injector to reduce the temperature of the hot-combustion-medium by 30%-80%, thereby forming a cold-expansion-medium at a temperature lower than 1100 degree Celsius by the end of second-intake-process;
the cold-expansion-process is performed after the completion of the second-intake-process, and the possible range of the cold-expansion-process is between 405 degree of crankshaft reference angle and 540 degree of crankshaft reference angle; during the cold-expansion-process, the cold-expansion-medium efficiently produces power at a slowly-decreasing expansion pressure, and the temperature of the cold-expansion-medium is regulated within the range of 400-1100 degree Celsius by adjusting the amount of high-boost-air being injected in the second-intake-process, such that all the carbon-monoxide-gas in said cold-expansion-medium is spontaneously converted into a carbon-dioxide-gas to produce more expansion force due to the low-temperature and oxygen-rich condition inside the cold-expansion-chamber;
the exhaust-process is performed with the associated exhaust-valve after the completion of the cold-expansion-process, and the cold-expansion-medium is expelled out of the cold-expansion-chamber during the exhaust-process.

2. A low-cost type Mackay Four-Stroke Engine System as defined in claim 1, wherein; said power-management-unit controls the fuel-supplying means of each cold-expansion-chamber, such that a fuel-rich air-fuel-mixture or a stoic air-fuel-mixture is formed by the end of the compression-process, thereby igniting said air-fuel-mixture as a fuel-rich hot-combustion-medium containing a high concentration of carbon-monoxide-gas during the hot-combustion-process; and said power-management-unit controls the reenergize-air-injector of each cold-expansion-chamber, such that an adequate amount of high-boost-air is injected to form an oxygen-rich cold-expansion-medium that is lower than 1100 degree Celsius by the end of the second-intake-process.

3. A low-cost type Mackay Four-Stroke Engine System as defined in claim 2, wherein; said reenergize-buffer includes an airflow-data sensor, and said power-management-unit includes a computation circuit for determining the actuation-time of each reenergize-air-injector and the amount of high-boost-air being injected in the second-intake-process, such that the temperature of the oxygen-rich cold-expansion-medium is regulated within the range of 400-1100 degree Celsius during the cold-expansion-process in order to effect a spontaneous conversion of carbon-dioxide-gas.

4. A low-cost type Mackay Four-Stroke Engine System as defined in claim 3, wherein; said power-management-unit increases the operation pressure of said reenergize-buffer in response to an increase in the engine load, thereby effecting an earlier actuation of each reenergize-air-injector for generating a higher average expansion-pressure during the cold-expansion-process.

5. A low-cost type Mackay Four-Stroke Engine System as defined in claim 4, wherein; said Mackay Four-Stroke Engine System further includes a power-saving mode for maintaining the temperature of said at least two cold-expansion-chambers in both an engine idling operation and a brake operation, wherein:
the power-management-unit disables the actuation of each reenergize-air-injector in the engine idling operation and the brake operation, such that each cold-expansion-chamber operates with only the intake-process, the compression-process, the hot-combustion-process, and the exhaust-process;
during the engine idling operation and the brake operation, the power-management-unit controls the operation speed of the air-compression means to prevent the reenergize-buffer from over-pressurized; wherein the power-management-unit may disengage a clutch between the compressor-transmission means and air-compression means.

6. A low-cost type Mackay Four-Stroke Engine System as defined in claim 5 further comprising:
f) a turbo-compressor and a turbo-turbine for recovering the kinetic energy of the expelled cold-expansion-medium, thereby producing a low-boost-air to said air-compression means;
g) a heat-transfer-catalytic-converter for recovering the thermal energy of the expelled cold-expansion-medium, thereby heating up a high-boost-air in said reenergize-buffer to reduce the workload of said air-compression means; and
h) said power-management-unit further includes a computation circuit for determining the optimum duration of the second-intake-process based on the compression efficiency of said air-compressor means, the crankshaft rpm of said at least two cold-expansion-chambers, the spark-ignition timings of said at least two cold-expansion-chamber, the oxygen-gas concentration of the expelled cold-expansion-medium, and the airflow data of the expelled cold-expansion-medium, thereby setting the actuation-time of each reenergize-air-injector to an optimum duration that enables the cold-expansion-medium to expand with the least heat-loss and a complete conversion of the carbon-dioxide-gas during the cold-expansion-process.

7. A low-cost type Mackay Four-Stroke Engine System as defined in claim 6, wherein; said air-compression means is a scroll-type air-compressor, a screw-type air-compressor, a rotary-type air-compressor, a piston-type air-compressor, a vane-type air-compressor, an axial-turbine type air-compressor, or a centrifugal-turbine type air-compressor.

8. A low-cost type Mackay Four-Stroke Engine System as defined in claim 2 further includes a battery, a motor, and an inverter for operating in a series-hybrid mode or a parallel-hybrid mode, thereby increasing the overall energy efficiency in the public transportation applications.

9. A Low-Cost Type Mackay Cold-Expansion Engine System comprising:
a) a power-management-unit;
b) an air-compressor for providing a source of high-boost-air, which is supplied to a reenergize-buffer; wherein, said air-compressor is driven by a compressor-motor to operate at a controlled speed determined by the power-management-unit, in order to maintain a regulated operation pressure of said reenergize-buffer in the range of 4-25 bar gauge;
c) at least two cold-expansion-chambers; wherein, each cold-expansion-chamber includes an air-intake-valve, a piston, a reenergize-air-injector, an ignition means, a fuel-supplying means, and an exhaust-valve; and
d) said power-management-unit controls all said reenergize-air-injectors, said ignition means, and said fuel-supplying means in order to perform the Simplified Mackay Four-Stroke Cycle in each cold-expansion-chamber; wherein the Simplified Mackay Four-Stroke Cycle consists of six processes, which are performed in the order of a first-intake-process, a compression-process, a hot-combustion-process, a second-intake-process, a cold-expansion-process, and an exhaust-process; wherein:
one Simplified Mackay Four-Stroke Cycle completes in every 720 degree of crankshaft rotation;
the first-intake-process and the compression-process are performed within the range between 0 degree of crankshaft reference angle and 360 degree of crankshaft reference angle, wherein an air-fuel-mixture, supplied by the associated air-intake-valve and fuel-supplying means, is compressed during the up-stroke of the associated piston;
the hot-combustion-process is performed within the range between 325 degree of crankshaft reference angle and 435 degree of crankshaft reference angle; during the hot-combustion-process, said compressed air-fuel-mixture is ignited with the associated spark-ignition means as a hot-combustion-medium at a temperature between 2500 degree Celsius and 1400 degree Celsius;
the second-intake-process is performed within the range between 400 degree of crankshaft reference angle and 460 degree of crankshaft reference angle; during the second-intake-process, a programmed amount of high-boost-air is injected into the cold-expansion-chamber by the associated reenergize-air-injector to reduce the temperature of the hot-combustion-medium by 30%-80%, thereby forming a cold-expansion-medium at a temperature lower than 1100 degree Celsius by the end of second-intake-process;
the cold-expansion-process is performed after the completion of the second-intake-process, and the possible range of the cold-expansion-process is between 405 degree of crankshaft reference angle and 540 degree of crankshaft reference angle; during the cold-expansion-process, the cold-expansion-medium efficiently produces power at a slowly-decreasing expansion pressure, and the temperature of the cold-expansion-medium is regulated within the range of 400-1100 degree Celsius during the cold-expansion-process by adjusting the amount of high-boost-air being injected in the second-intake-process, so that all the carbon-monoxide-gas in said cold-expansion-medium is spontaneously converted into a carbon-dioxide-gas to produce more expansion force due to the low-temperature and oxygen-rich condition inside the cold-expansion-chamber;
the exhaust-process is performed with the associated exhaust-valve after the completion of the cold-expansion-process, and the cold-expansion-medium is expelled out of the cold-expansion-chamber during the exhaust-process.

10. A low-cost type Mackay Four-Stroke Engine System as defined in claim 9, wherein; said power-management-unit controls the fuel-supplying means of each cold-expansion-chamber, such that a fuel-rich air-fuel-mixture or a stoic air-fuel-mixture is formed by the end of the compression-process, thereby igniting said air-fuel-mixture as a fuel-rich hot-combustion-medium containing a high concentration of carbon-monoxide-gas during the hot-combustion-process; and said power-management-unit controls the reenergize-air-injector of each cold-expansion-chamber, such that an adequate amount of high-boost-air is injected to form an oxygen-rich cold-expansion-medium that is lower than 1100 degree Celsius by the end of the second-intake-process.

11. A low-cost type Mackay Four-Stroke Engine System as defined in claim 10 further comprising:
e) a turbo-compressor and a turbo-turbine for recovering the kinetic energy of the expelled cold-expansion-medium, thereby producing a low-boost-air to said air-compression means;
f) a heat-transfer-catalytic-converter for recovering the thermal energy of the expelled cold-expansion-medium, thereby heating up a high-boost-air in said reenergize-buffer to reduce the workload of said air-compression means; and
g) said power-management-unit further includes a computation circuit for determining the optimum duration of the second-intake-process based on the compression efficiency of said air-compressor means, the crankshaft rpm of said at least two cold-expansion-chambers, the spark-ignition timings of said at least two cold-expansion-chamber, the oxygen-gas concentration of the expelled cold-expansion-medium, and the airflow data of the expelled cold-expansion-medium, thereby setting the actuation-time of each reenergize-air-injector to an optimum duration that enables the cold-expansion-medium to expand with the least heat-loss and a complete conversion of the carbon-dioxide-gas during the cold-expansion-process.

12. A low-cost type Mackay Four-Stroke Engine System as defined in claim 11 further includes a battery, a regeneration-motor, and an inverter for operating in a series-hybrid mode or a parallel-hybrid mode, thereby increasing the overall energy efficiency in the public transportation applications.

13. A low-cost type Mackay Four-Stroke Engine System as defined in claim 12, wherein; said power-management-unit increases the operation pressure of said reenergize-buffer in response to an increase in the engine load, thereby effecting an earlier actuation of each reenergize-air-injector for generating a higher average expansion-pressure during the cold-expansion-process.

14. A Diesel Type Mackay Four-Stroke Engine System comprising:
a) a power-management-unit and at least two cold-expansion-chambers; each cold-expansion-chamber includes a piston, an air-intake-valve, a reenergize-air-injector, a fuel-injector, and an exhaust-means for performing a Simplified Mackay Four-Stroke Cycle; wherein the Mackay Cold-expansion Cycle consists of six processes, which are performed in the order of a first-intake-process, a compression-process, a hot-combustion-process, a second-intake-process, a cold-expansion-process, and an exhaust-process;
b) a reenergize-buffer for buffering a high-boost-air, which is supplied to the reenergize-air-injector of each cold-expansion-chamber; wherein, each reenergize-air-injector injects a programmed amount of high-boost-air into the associated cold-expansion-chamber after the completion of the hot-combustion-process;
c) an air-compressor driven by a variable-speed-motor or a compressor-transmission for regulating the operation pressure of the reenergize-buffer within the range of 4-25 bar gauge;
d) said power-management-unit controls all said air-intake-valves, said reenergize-air-injectors, and said fuel-injectors for performing the Simplified Mackay Cold-Expansion Cycle with diesel fuel in each cold-expansion chamber; wherein:
the first-intake-process is performed within the range between 0 degree of crankshaft reference angle and 270 degree of crankshaft reference angle, wherein the associated air-intake-valve is opened to admit air into the cold-expansion-chamber;
the compression-process is performed within the range between 180 degree of crankshaft reference angle and 360 degree of crankshaft reference angle; during the compression-process, the associated piston compresses the air in the cold-expansion-chamber;
the hot-combustion-process is performed within the range between 325 degree of crankshaft reference angle and 435 degree of crankshaft reference angle; during the hot-combustion-process, a diesel fuel is injected into the cold-expansion-chamber by the associated fuel-injector, thereby igniting the diesel fuel with the compressed air to form a hot-combustion-medium at a temperature between 2500 degree Celsius and 1400 degree Celsius;
the second-intake-process is performed within the range between 400 degree of crankshaft reference angle and 460 degree of crankshaft reference angle; during the second-intake-process, a programmed amount of high-boost-air is injected into the cold-expansion-chamber by the associated reenergize-air-injector to reduce the temperature of the hot-combustion-medium by 30%-80%, thereby forming a cold-expansion-medium at a temperature lower than 1100 degree Celsius by the end of second-intake-process;
the cold-expansion-process is performed after the completion of the second-intake-process, and the possible range of the cold-expansion-process is between 405 degree of crankshaft reference angle and 540 degree of crankshaft reference angle; during the cold-expansion-process, the cold-expansion-medium efficiently produces power at a slowly-decreasing expansion pressure, and the temperature of the cold-expansion-medium is regulated within the range of 400-1100 degree Celsius during the cold-expansion-process by adjusting the amount of high-boost-air being injected in the second-intake-process, so that all the carbon-monoxide-gas in said cold-expansion-medium is spontaneously converted into a carbon-dioxide-gas to produce more expansion force due to the low-temperature and oxygen-rich condition inside the cold-expansion-chamber;
the exhaust-process is performed with the associated exhaust-valve after the completion of the cold-expansion-process, and the cold-expansion-medium is expelled out of the cold-expansion-chamber during the exhaust-process.

15. A Diesel Type Mackay Four-Stroke Engine System as defined in claim 14, wherein; said power-management-unit controls the fuel-injector of each cold-expansion-chamber, such that the diesel fuel and the compressed air are ignited as the hot-combustion-medium at a fuel-rich ratio or a stoic ratio during the hot-combustion-process; and said power-management-unit controls the reenergize-air-injector of each cold-expansion-chamber, such that an adequate amount of high-boost-air is injected to form an oxygen-rich cold-expansion-medium that is lower than 1100 degree Celsius by the end of the second-intake-process.

16. A Diesel Type Mackay Four-Stroke Engine System as defined in claim 14, wherein; said power-management-unit controls the fuel-injector of each cold-expansion-chamber, such that the diesel fuel is injected two times during each cycle of the Simplified Mackay Four-Stroke Cycle; wherein a first injection of diesel fuel is performed before 360 degree of crankshaft reference angle to induce an ignition, and a second injection of diesel fuel is performed before the second-intake-process to reduce the formation of soot in a heavy load operation.

17. A Diesel Type Mackay Four-Stroke Engine System as defined in claim 14 further comprising:
e) a turbo-compressor and a turbo-turbine for recovering the kinetic energy of the expelled cold-expansion-medium, thereby producing a low-boost-air to said air-compression means;
f) a heat-transfer-catalytic-converter for recovering the thermal energy of the expelled cold-expansion-medium, thereby heating up a high-boost-air in said reenergize-buffer to reduce the workload of said air-compression means; and
g) said power-management-unit further includes a computation circuit for determining the optimum duration of the second-intake-process based on the crankshaft rpm of said at least two cold-expansion-chambers, the ignition timings of said at least two cold-expansion-chamber, the oxygen-gas concentration of the expelled cold-expansion-medium, and the airflow data of the expelled cold-expansion-medium, thereby setting the actuation-time of each reenergize-air-injector to an optimum duration that enables the cold-expansion-medium to expand with the least heat-loss and a complete conversion of the carbon-dioxide-gas during the cold-expansion-process.

18. A Diesel Type Mackay Four-Stroke Engine System as defined in claim 14, wherein; said air-compressor is a scroll-type air-compressor, a screw-type air-compressor, a rotary-type air-compressor, a piston-type air-compressor, a vane-type air-compressor, an axial-turbine type air-compressor, or a centrifugal-turbine type air-compressor.

19. A Diesel Type Mackay Four-Stroke Engine System as defined in claim 14, wherein; said power-management-unit increases the operation pressure of said reenergize-buffer in response to an increase in the engine load, thereby effecting an earlier actuation of each reenergize-air-injector for generating a higher average expansion-pressure during the cold-expansion-process.

20. A low-cost type Mackay Four-Stroke Engine System comprising:
a) at least two cold-expansion-chambers; wherein each cold-expansion-chamber includes an ignition means, a fuel-supplying means, a reenergize-air-injector, a piston, an air-intake-valve, and an exhaust-valve; each cold-expansion-chamber completes a Simplified Mackay Four-Stroke Cycle in four strokes, and the Simplified Mackay Four-Stroke Cycle performs in the order of a first-intake-process, a compression-process, a hot-combustion-process, a second-intake-process, a cold-expansion-process, and an exhaust-process;
b) an air-compressor and a reenergize-buffer; wherein said reenergize-buffer supplies high-boost-air to the reenergize-air-injectors of said at least two cold-expansion-chambers;
c) a power-management-unit for controlling operation speed of said air-compressor; wherein said air-compressor is driven by a compression-transmission or an electric-motor, controlled by said power-management-unit, thereby supplying a high-boost-air at a regulated air-pressure to the reenergize-buffer; and
d) said power-management-unit controls all said ignition means, said fuel-supplying means, said reenergize-air-injectors of said at least two cold-expansion-chambers for optimizing the energy efficiency by controlling the temperature and the oxygen-gas concentration during a 3rd-Stroke of each cold-expansion-chamber, wherein:
the hot-combustion-process is performed within a range from the min chamber volume to at least 18% of the max chamber volume, wherein the temperature of a hot-combustion-medium inside the cold-expansion-chamber is at 1400-2500 degree Celsius;
the second-intake-process is performed within a range from 18% of the max chamber volume to 55% of the max chamber volume, wherein a programmed amount of high-boost-air is injected into the cold-expansion-chamber to form a cold-expansion-medium at a temperature lower than 1100 degree Celsius; and
the cold-expansion-process is performed within a range from 25% of the max chamber volume to 100% of the max chamber volume, wherein the cold-expansion-medium generates more expansion force by accelerating the conversion of carbon-dioxide-gas.
